(19) United States
(12) Patent Application Publication
(10) Pub. No.: US 2026/0276964 A1
(43) Pub. Date: Sep. 17, 2026

(54) FLUORESCENCE MICROSCOPE

(71) Applicant: Keyence Corporation, Osaka (JP)

(72) Inventors: Kazuki NATORI, Osaka (JP); Tsuyoshi SUENAGA, Osaka (JP)

(73) Assignee: Keyence Corporation, Osaka (JP)

(21) Appl. No.: 19/554,688

(22) Filed: Mar. 3, 2026

(30) Foreign Application Priority Data
Mar. 13, 2025 (JP) 2025-039939
Jan. 5, 2026 (JP) 2026-000333

(51) Int. Cl. G02B 21/00; G01N 21/64; G02B 21/36; G06F 3/04817; G06F 3/0482; G06F 3/04845; G06F 3/04847

(52) U.S. Cl. CPC G02B 21/008; G01N 21/6458; G02B 21/0076; G02B 21/368; G06F 3/04817; G06F 3/04845; G06F 3/04847; G06F 3/0482

(57) ABSTRACT

By making it easy to understand at which position in the whole an individual navigation image has been acquired, operability is improved. A positioning user interface screen that designates an observation position of an observation target on a map image of a stage and a height setting user interface screen that receives adjustment of an observation height of the observation target while displaying an image of the observation target at the observation position are displayed on a display section. The setting of the observation position is received on the positioning user interface screen, and the setting of the observation height is received on the height setting user interface screen. An observation image is acquired as an individual navigation image on the basis of an image acquisition instruction. A navigation screen in which the individual navigation image is superimposed and displayed on the positioning user interface screen is displayed on the display section.

### CROSS-REFERENCE TO RELATED APPLICATIONS

The present application claims foreign priority based on Japanese Patent Application No. 2025-039939, filed Mar. 13, 2025, and No. 2026-000333, filed Jan. 5, 2026, the contents of which are incorporated herein by references.

### BACKGROUND OF THE INVENTION

### 1. Technical Field

The present disclosure relates to a fluorescence microscope.

### 2. Description of the Related Art

For example, a fluorescence microscope disclosed in JP2008-139794A enables fluorescence observation of an observation target by irradiating the observation target with excitation light and detecting fluorescence generated in the observation target. Furthermore, the fluorescence microscope of JP2008-139794A can also perform transmission observation of an observation target by irradiating the observation target with transmitted illumination and detecting light transmitted through the observation target.

When the fluorescence microscope of JP2008-139794A is used, a navigation image displaying the entire observable range is displayed on a display section.

In this navigation image, the currently observed position is displayed by a cross-shaped grid.

Since the microscope has a narrow field of view, it is expected to improve usability by acquiring a wide-field of view navigation image.

However, for example, a plurality of kinds of samples may be simultaneously observed at a time, or a difference in conditions of the same sample may be imaged and observed as in observation on a well plate. In such a case, an observation image of each observation region is acquired as a plurality of navigation images, but it has been difficult to grasp a positional relationship of the observation region in the entire slide only with individual navigation images, and operability when moving to different navigation images repeatedly with a sample such as a well plate is not good.

### SUMMARY OF THE INVENTION

The present disclosure has been made in view of such a point, and an object of the present disclosure is to improve operability by making it easy to understand at which position in the whole an individual navigation image has been acquired.

In order to achieve the above object, a fluorescence microscope according to one embodiment of the present disclosure includes: a display control section configured to cause a display section to display a positioning user interface screen that designates an observation position of an observation target on a map image of a stage on which the observation target is placed, and a height setting user interface screen that receives adjustment of an observation height of the observation target while displaying an image of the observation target at the observation position designated on the positioning user interface screen; a reception section configured to receive setting of the observation position on the positioning user interface screen displayed on the display section by the display control section and receive setting of the observation height on the height setting user interface screen displayed on the display section by the display control section; a first drive section configured to drive the stage to the observation position set by the reception section; a second drive section configured to drive the stage to the observation height set by the reception section; an illumination section configured to irradiate the observation target placed on the stage with observation light; an observation optical system configured to collect light generated from the observation target by being irradiated with the observation light from the illumination section; a detection section configured to detect the light collected by the observation optical system; an observation condition setting section configured to set an observation condition of the observation optical system; an image processing section configured to generate an observation image on the basis of the light detected by the detection section; and an image acquisition section configured to, on the basis of an image acquisition instruction, acquire the observation image generated by the image processing section as an individual navigation image.

The display control section can cause the display section to display a navigation screen in which the individual navigation image acquired by the image acquisition section is superimposed and displayed on a map image of the positioning user interface screen.

According to this configuration, when a user designates the observation position of the observation target on the map image of the stage and further adjusts the observation height of the observation target, the stage is driven by the first drive section and the second drive section, and the observation image of the designated place is generated by the image processing section. The observation image generated by the image processing section is acquired as the individual navigation image. Since the individual navigation image is superimposed and displayed on the positioning user interface screen, it is easy to understand at which position in the observation target the individual navigation image is acquired.

As described above, since it is easy to understand at which position in the whole the individual navigation image is acquired, the operability of the fluorescence microscope can be improved.

### BRIEF DESCRIPTION OF THE DRAWINGS

FIG. 1 is a diagram illustrating a configuration of a fluorescence microscope according to an embodiment of the present invention;

FIG. 2 is a diagram describing an internal structure of a microscope body and a light source unit;

FIG. 3 is a schematic diagram illustrating an optical path of the fluorescence microscope;

FIG. 4 is a perspective view of a microscope body in which a base housing, a transmitted illumination section, a stage frame, an upper frame, and the like are omitted;

FIG. 5 is a plan view of a filter unit;

FIG. 6 is a perspective view of the filter unit as viewed from above;

FIG. 7 is a perspective view of a single filter cube as viewed from above;

FIG. 8 is a perspective view of the single filter cube as viewed from below;

FIG. 9 is a perspective view of an emission filter unit as viewed from above;

FIG. 10 is a cross-sectional view of a transmitted illumination body;

FIG. 11 is a diagram illustrating an example of a display screen;

FIG. 12 is a diagram illustrating an example of an enlarged positioning user interface screen;

FIG. 13A is a diagram illustrating an example of a circular holder guide;

FIG. 13B is a diagram illustrating an example of a rectangular holder guide;

FIG. 13C is a diagram illustrating an example of a 6-hole multi-well guide;

FIG. 13D is a diagram illustrating an example of a 96-hole multi-well guide;

FIG. 14A is a diagram illustrating an example in which a plurality of individual navigation images of different observation targets is displayed;

FIG. 14B is a diagram illustrating an example in which individual navigation images of a plurality of the same observation targets are displayed;

FIG. 14C is a diagram illustrating an example in which only one entire navigation image is displayed;

FIG. 15A is a diagram illustrating a case where an observation position is selected on the rectangular holder guide;

FIG. 15B is a diagram illustrating a case where an observation position is selected on the multi-well guide;

FIG. 16 is a diagram illustrating an example of an image displayed in a live view before focusing;

FIG. 17 is a diagram illustrating an example of an image displayed in a live view after focusing;

FIG. 18 is a diagram illustrating a state in which an individual navigation image is acquired;

FIG. 19 is a diagram illustrating an example of an individual navigation image obtained by capturing an image of only an existence range of an observation target;

FIG. 20 is a diagram illustrating a case where a sub-observation image is acquired in a spiral pattern;

FIG. 21 is a diagram illustrating a case where only one sub-observation image is acquired;

FIG. 22 is a diagram illustrating an example in which an individual navigation image is displayed as a thumbnail image;

FIG. 23 is an image illustrating an example in which cell addresses in a well plate are held;

FIG. 24 is a diagram illustrating an example of a structure of data held in association with a navigation image;

FIG. 25 is a diagram corresponding to FIG. 12 illustrating an example in which a plurality of navigation images is acquired;

FIG. 26 is a diagram schematically illustrating a state in which a confocal unit is attached; and

FIG. 27 is a diagram illustrating an example of a display screen capable of switching between a wide-field fluorescence observation mode and a confocal fluorescence observation mode.

### DETAILED DESCRIPTION

Hereinafter, embodiments of the present invention will be described in detail with reference to the drawings. Note that the following description of preferred embodiments is merely exemplary in nature and is not intended to limit the present invention, its application, or its use. For example, the relative size and positional relationship of each member illustrated in the drawings are for describing one embodiment, and do not limit the present invention.

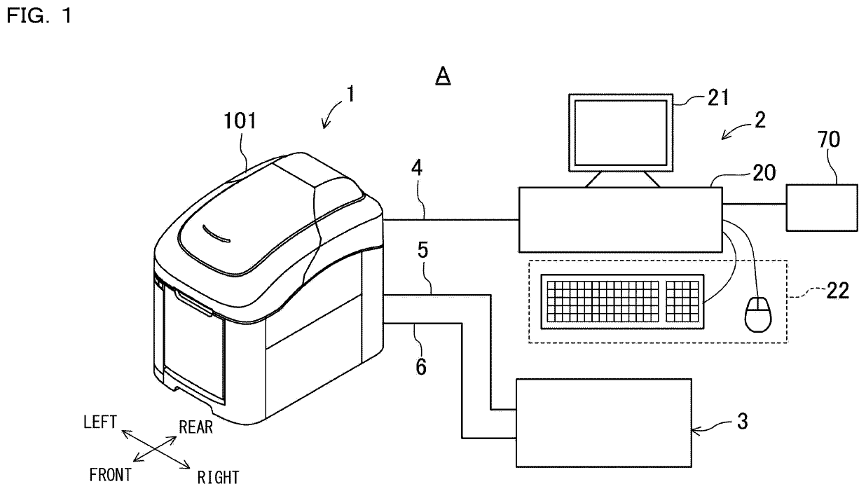

FIG. 1 is a diagram illustrating a configuration of a fluorescence microscope A according to an embodiment of the present invention. The fluorescence microscope A can perform fluorescence observation of an observation target. Furthermore, in addition to the fluorescence observation, the fluorescence microscope A can perform bright field observation, dark field observation, phase difference observation, differential interference observation, and the like using light transmitted through the observation target. In the following description, the bright field observation, the dark field observation, the phase difference observation, and the differential interference observation using light transmitted through the observation target are collectively referred to as transmission observation.

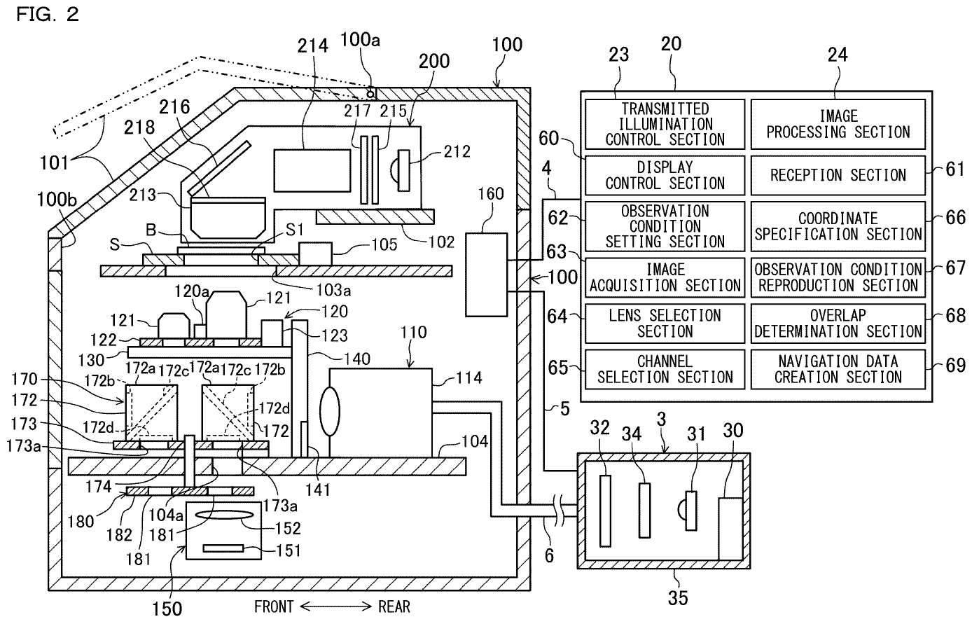

The observation target B (schematically illustrated in FIG. 2) observed in the present embodiment is a biological specimen or the like including various proteins. In a case where fluorescence observation of a biological specimen is performed, a fluorescent reagent that binds to a specific protein is used for the observation target B. Examples of the fluorescent reagent include green fluorescent protein (GFP), TexasRed, and diamidinophenylindole (DAPI), but fluorescence observation using a fluorescent reagent other than these is also possible.

For example, the GFP absorbs light having a wavelength of around 490 nm and emits light having a wavelength of around 510 nm. The TexasRed absorbs light having a wavelength of around 596 nm and emits light having a wavelength of around 620 nm. The DAPI absorbs light having a wavelength of around 345 nm and emits light having a wavelength of around 455 nm. As described above, the wavelength of light absorbed by the fluorescent reagent is different, and the wavelength of light emitted is also different.

The fluorescence microscope A includes, for example, a microscope body 1, an electronic computer 2, and a light source unit 3. Therefore, the fluorescence microscope A can also be referred to as a fluorescence microscope system or a fluorescence microscope device. The microscope body 1 and the electronic computer 2 are connected by a first wiring 4 and can communicate with each other. The microscope body 1 and the light source unit 3 are connected by a second wiring 5 and can communicate with each other. Moreover, the microscope body 1 and the light source unit 3 are connected by a fiber cable (transmission member) 6, and excitation light generated by the light source unit 3 can be transmitted to the microscope body 1 via the fiber cable 6 as described later. As described above, the fluorescence microscope A also includes the first wiring 4, the second wiring 5, and the fiber cable 6. As the first wiring 4, for example, a local area network (LAN) cable, a universal serial bus (USB) cable, or the like can be used. As the second wiring 5, for example, a cable in which a power supply line and a signal line are integrated can be used.

Note that the electronic computer 2 may be omitted, and the function of the electronic computer 2 may be incorporated in the microscope body 1. Furthermore, the light source unit 3 may be omitted, and the function of the light source unit 3 may be incorporated in the microscope body 1. Furthermore, the microscope body 1 may be configured by a single device.

As illustrated in FIG. 2, the light source unit 3 includes a power supply device 30, an illumination section 31, an excitation filter 32 that selectively transmits a wavelength of excitation light emitted from the illumination section 31, a light shielding mechanism 34, and an excitation illumination housing 35. The power supply device 30, the illumination section 31, the excitation filter 32, and the light shielding mechanism 34 are accommodated in the excitation illumination housing 35. A commercial power supply is connected to the power supply device 30, and power is supplied from the commercial power supply. The power supply device 30 supplies power supplied from the commercial power supply to the illumination section 31 and also supplies the power to the microscope body 1 via the second wiring 5. A power supply mode is not limited to the above-described mode, and the commercial power supply may be connected to the microscope body 1.

The illumination section 31 is a part that generates light used for observation, and includes, for example, a white light emitting diode (LED) or the like. The illumination section 31 may be configured with a light source other than a white light emitting diode (LED), and may be, for example, another light source such as a metal halide lamp, a mercury lamp, or a xenon lamp. The light emitted from the illumination section 31 is excitation light used at the time of fluorescence observation.

The light shielding mechanism 34 is, for example, a mechanical shutter. The light shielding mechanism 34 is disposed so as to be located on an optical path of light emitted from the illumination section 31. In a case where the light shielding mechanism 34 is in the non-light shielding state, the light emitted from the illumination section 31 passes through the light shielding mechanism 34 and enters the excitation filter 32. On the other hand, in a case where the light shielding mechanism 34 is in a light shielding state, the light emitted from the illumination section 31 is blocked and is not incident on the excitation filter 32. The light shielding mechanism 34 may include a light modulation element capable of switching between passage and blocking of light emitted from the illumination section 31. The light shielding mechanism 34 is in a non-light shielding state in a case where fluorescence observation of the observation target B is performed, and is in a light shielding state in a case where fluorescence observation of the observation target B is not performed.

The excitation filter 32 includes a plurality of excitation filters corresponding to the types of fluorescent reagents. When the light emitted from the illumination section 31 enters the excitation filter 32, the wavelength of the excitation light is selectively transmitted and emitted to one end portion of the fiber cable 6. The excitation light incident on one end portion of the fiber cable 6 is transmitted to the other end portion of the fiber cable 6 and is incident on the microscope body 1. The fiber cable 6 may be either a glass fiber or a quartz fiber. Furthermore, a liquid light guide or the like can also be used as the transmission member. Since the light source unit 3 is separated from the microscope body 1 in this manner, it is not necessary to provide the illumination section 31 that easily generates heat in the microscope body 1.

Therefore, a countermeasure for heat dissipation of the microscope body 1 becomes unnecessary, and it is possible to achieve both irradiation of strong excitation light and miniaturization of the microscope body 1.

The microscope body 1 includes a base housing 100. Since the base housing 100 is separated from the excitation illumination housing 35, it can be installed separately from the excitation illumination housing 35. In the description of this embodiment, as illustrated in a front-rear direction and a left-right direction in FIG. 1, a side facing an observer (user) who performs observation using the microscope body 1 is referred to as a front side of the microscope body 1, a side opposite to the side facing the observer is referred to as a rear side of the microscope body 1, a right side as viewed from the observer is simply referred to as a right side, and a left side as viewed from the observer is simply referred to as a left side. The definitions of these directions are for convenience of description of the embodiment, and do not limit the present invention.

An opening 100b is formed in an upper portion of the base housing 100. An upper surface lid 101 for opening and closing the opening 100b is provided in the upper portion of the base housing 100. The rear side of the upper surface lid 101 is connected to the upper portion of the base housing 100 via a shaft 100a extending in the left-right direction. As indicated by a virtual line, the opening 100b of the base housing 100 can be opened by rotating the upper surface lid 101 upward around the shaft 100a. On the other hand, by closing the opening 100b of the base housing 100 as indicated by the solid line, the inside of the base housing 100 can be made a dark room.

The base housing 100 of the microscope body 1 includes an upper frame 102, a stage frame 103, and a lower frame 104. The upper frame 102 is provided in an upper portion inside the base housing 100. The stage frame 103 is provided below the upper frame 102 inside the base housing 100. The lower frame 104 is provided below the stage frame 103 inside the base housing 100. The upper frame 102, the stage frame 103, and the lower frame 104 extend horizontally and are in parallel positional relationship with each other. Openings 103a and 104a through which light used for observation of the observation target B passes are formed in the stage frame 103 and the lower frame 104, respectively. The opening 103a of the stage frame 103 and the opening 104a of the lower frame 104 are formed such that their centers are located on the same straight line extending in an up and down direction.

The microscope body 1 includes a stage S on which the observation target B is placed.

The stage S is accommodated in the base housing 100 and is placed on the upper surface of the stage frame 103. The stage S also has an opening S1 through which light used for observation of the observation target B passes. The opening S1 of the stage S is disposed so as to overlap the opening 103a of the stage frame 103 in plan view. Moreover, an XY driving device 105 that drives the stage S in an X direction and a Y direction orthogonal to each other is attached to the upper surface of the stage frame 103. The X direction is the left-right direction, and the Y direction is the front-rear direction. That is, the XY driving device 105 is a device for moving the stage S in a horizontal direction.

The microscope body 1 includes an illumination module (illumination section) 110 that irradiates the observation target B placed on the stage S with excitation light as observation light. The illumination module 110 is accommodated in the base housing 100 and attached to the lower frame 104. In the present embodiment, the illumination module 110 is provided behind the optical module 120 described later. Note that the illumination module 110 may be provided below the optical module 120.

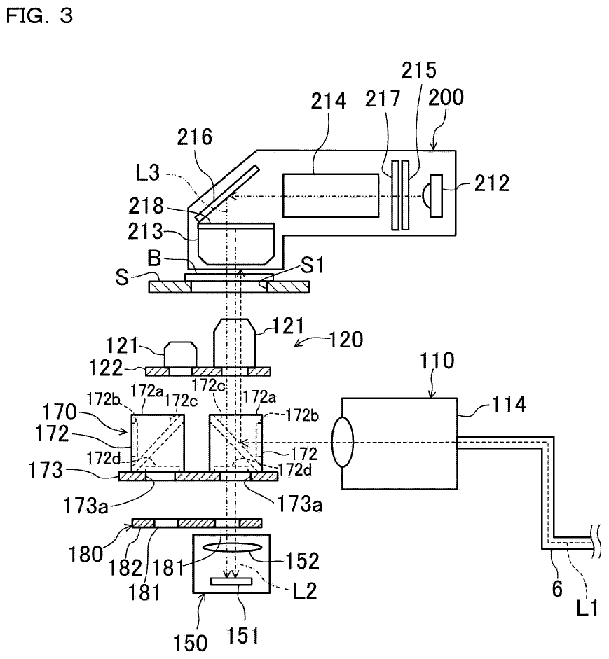

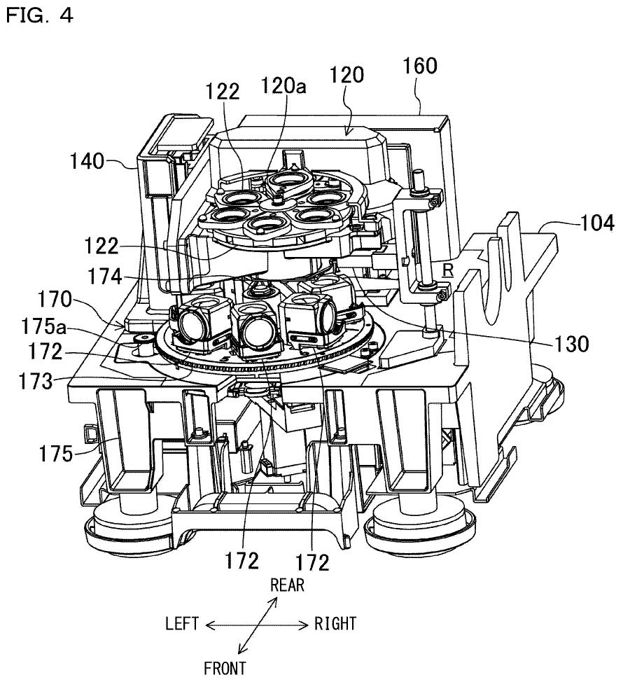

As illustrated in FIG. 3, the other end (the end on the side from which the excitation light is emitted) of the fiber cable 6 is connected to the rear side of the illumination module 110.

In FIG. 3, a broken line L1 indicates an optical path of the excitation light.

The illumination module 110 is an excitation illumination section that irradiates the observation target B placed on the stage S with excitation light for fluorescence observation, and includes a module case 114. The other end portion of the fiber cable 6 is connected to the lower portion on the rear side of the module case 114. Furthermore, an optical modulation element that modulates the excitation light emitted from the fiber cable 6 may be provided in the module case 114.

The excitation light emitted from the module case 114 is emitted forward from the front side of the module case 114. The optical path of the excitation light emitted from the module case 114 is along the X direction.

The microscope body 1 includes an optical module 120, a Z-plate 130, and a Z-drive module 140. The optical module 120, the Z-plate 130, and the Z-drive module 140 are accommodated in the base housing 100. The optical module 120 is disposed on the optical path L1 of the excitation light emitted from the illumination module 110, collects the excitation light emitted from the illumination module 110, guides the excitation light to the observation target B, and collects the fluorescence generated in the observation target B. In FIG. 3, an optical path of fluorescence generated in the observation target B is indicated by a one-dot chain line L2. The optical module 120 is provided in front of the illumination module 110.

The Z-plate 130 is a member connected to the optical module 120, is provided between the stage frame 103 and the lower frame 104, and extends along the XY plane.

The optical module 120 includes a plurality of objective lenses 121, a revolver 122, and a revolver drive device 123. The number of the objective lenses 121 is not particularly limited, and may be any number. The objective lens 121 is disposed below the stage S, and is a member for collecting fluorescence generated from the observation target B by being irradiated with excitation light from the illumination module 110 at the time of fluorescence observation.

Furthermore, at the time of transmission observation, the objective lens 121 collects the transmitted light emitted from the transmitted illumination section 200 to be described later and transmitted through the observation target B. The objective lens 121 is an observation optical system. The optical axis of each objective lens 121 is along the Z direction.

The revolver 122 is provided on the Z-plate 130 and is supported by the Z-plate 130 so as to be rotatable about a revolver shaft 120a extending in the vertical direction (Z direction). The plurality of objective lenses 121 is detachably attached to the revolver 122 in a state of being disposed so as to surround the revolver shaft 120a.

The revolver drive device 123 is attached to the upper surface of the Z-plate 130. By rotating the revolver 122 around the revolver shaft 120a by the revolver drive device 123, a desired one objective lens 121 among the plurality of objective lenses 121 is disposed immediately below the opening 103a of the stage frame 103, and the optical axis of the objective lens 121 is disposed on the optical path L2 of the fluorescence generated in the observation target B and the optical path L3 of the transmitted light. In this manner, the objective lens 121 used for observation can be switched by the revolver drive device 123. That is, the revolver 122 is a member in which the plurality of objective lenses 121 is disposed to be rotatable about the revolver shaft 120a and that switches the objective lens 121 disposed on the observation optical path.

The Z-drive module 140 is provided in a portion on the left side and the rear side of the lower frame 104. A lower portion of the Z-drive module 140 is attached to the upper surface of the lower frame 104, and the Z-drive module 140 has a shape protruding upward from the upper surface of the lower frame 104.

The Z-drive module 140 is connected to the Z-plate 130 and moves the objective lens 121, the revolver 122, and the revolver drive device 123 of the optical module 120 connected to the Z-plate 130 in the Z-direction. The Z-drive module 140 includes an electric adjustment mechanism 141. By driving the Z-plate 130 in the Z direction by the electric adjustment mechanism 141, the relative distance in the Z direction between the objective lens 121 used for observation and the observation target B is adjusted.

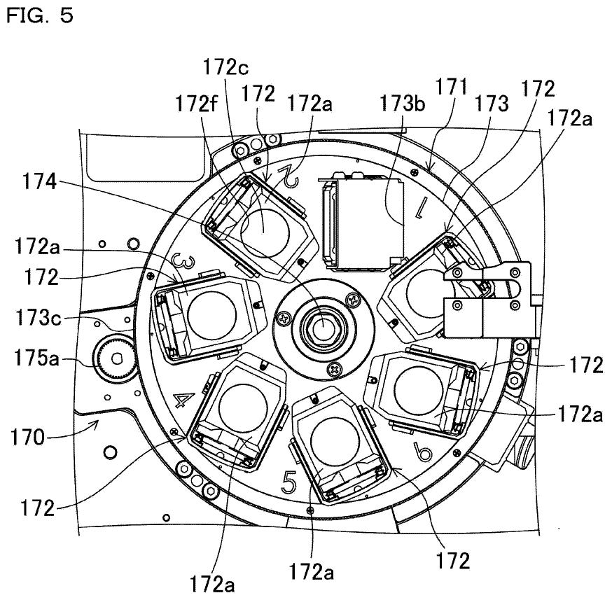

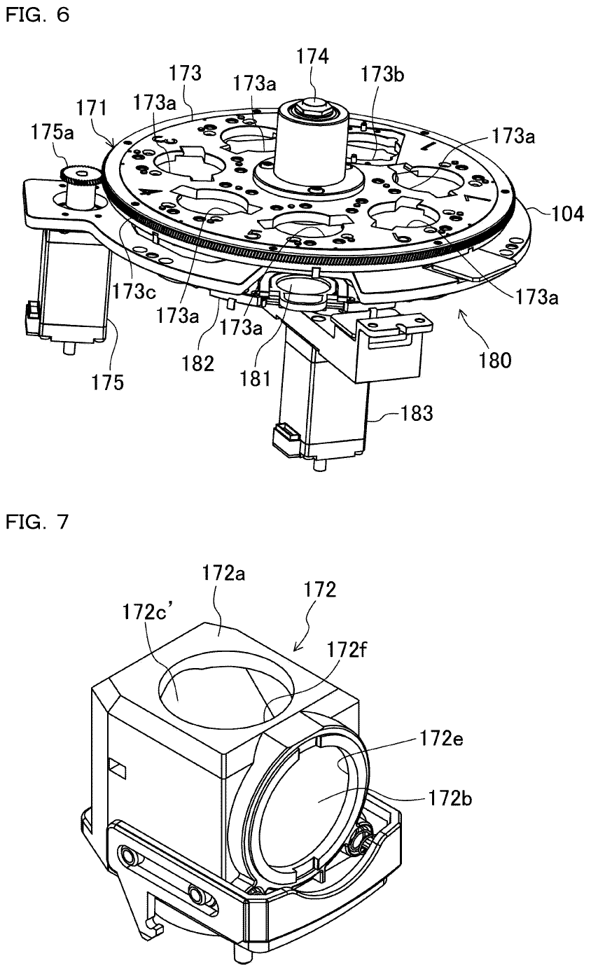

As illustrated in FIGS. 5 and 6, the microscope body 1 includes a filter unit 170 accommodated in the base housing 100. The filter unit 170 is disposed below the revolver 122 and includes a filter switching device 171 and a plurality of filter cubes 172. The filter switching device 171 includes a filter turret 173 to which the plurality of filter cubes 172 is detachably attached, a support shaft 174 that supports the filter turret 173, and a turret drive motor 175.

The support shaft 174 extends in the up and down direction. A portion intermediate in the up and down direction of the support shaft 174 is attached to the lower frame 104. The upper portion of the support shaft 174 protrudes upward from the upper surface of the lower frame 104. A central portion of the filter turret 173 is supported on an upper portion of the support shaft 174 so as to be relatively rotatable.

As illustrated in FIG. 6, the filter turret 173 has a disk shape. In the filter turret 173, a plurality of through holes 173a and 173b penetrating in the up and down direction is formed at intervals in a circumferential direction of the support shaft 174. The intervals between the through holes 173a and 173b in the circumferential direction are equal. In this embodiment, the seven through holes 173a and 173b are formed, and the filter cube 172 can be attached to the six through holes 173a among them, while the filter cube 172 cannot be attached to one through hole 173b.

The through hole 173b formed in the filter turret 173 is a hole for passing light transmitted through the observation target B at the time of transmission observation. At the time of transmission observation, the filter turret 173 is rotated such that the through hole 173b is disposed on the optical path L3 of the light transmitted through the observation target B. In this manner, by rotating the filter turret 173, it is possible to switch between a state (inserted state) in which the filter cube 172 and the absorption filter 172d included in the filter cube 172 are disposed on the observation optical path and a state (removed state) in which the filter cube 172 and the absorption filter 172d included in the filter cube 172 are not disposed. That is, the filter turret 173 is a member that inserts and removes the filter cube 172 and the absorption filter 172d included in the filter cube 172 on the observation optical path.

A large number of driven teeth 173c are provided in the circumferential direction on the outer peripheral portion of the filter turret 173. The turret drive motor 175 is provided with a pinion gear 175a that meshes with the driven teeth 173c. When the turret drive motor 175 is activated to rotate the pinion gear 175a, the filter turret 173 can be rotated about the support shaft 174. The rotation angle of the filter turret 173 can be any rotation angle by controlling the turret drive motor 175.

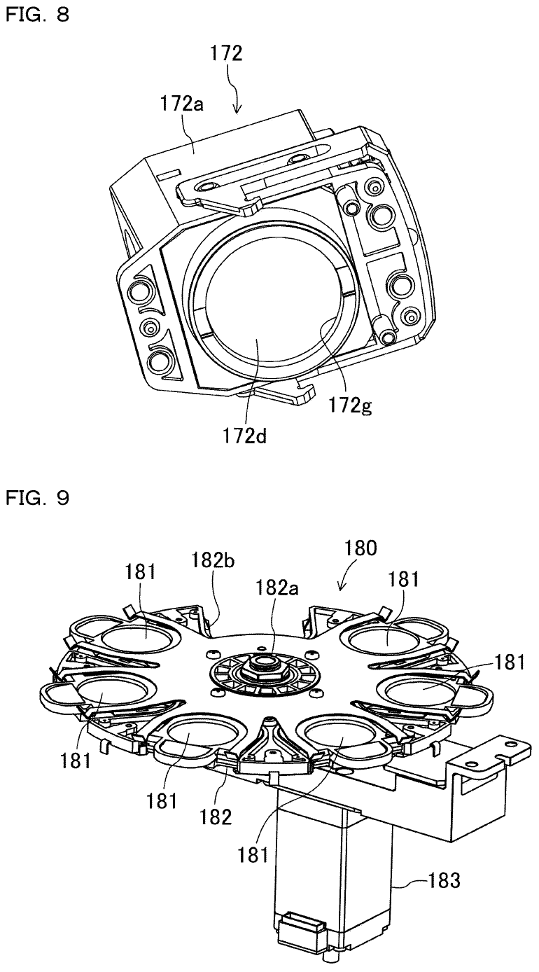

As illustrated in FIGS. 7 and 8, each filter cube 172 includes a frame 172a having an aerial structure, an excitation filter 172b, a dichroic mirror 172c, and an absorption filter 172d. The frame 172a is a cubic member that supports the excitation filter 172b, the dichroic mirror 172c, and the absorption filter 172d. Since each filter cube 172 is disposed below the revolver 122, the excitation filter 172b, the dichroic mirror 172c, and the absorption filter 172d are also disposed below the revolver 122. Since a plurality of the filter cubes 172 is provided, a plurality of excitation filters 172b, a plurality of the dichroic mirrors 172c, and a plurality of the absorption filters 172d are also provided corresponding to the number of filter cubes 172.

The frame 172a includes an entrance window 172e through which the excitation light from the illumination module 110 is incident, an upper emission window 172f through which the excitation light is emitted, and a lower emission window 172g through which the fluorescence generated in the observation target B is emitted. The entrance window 172e is formed on a side surface of the frame 172a, and an excitation filter 172b is provided in the entrance window 172e. The upper emission window 172f is formed on the upper surface of the frame 172a. The lower emission window 172g is formed on the lower surface of the frame 172a, that is, a surface opposed to the surface in the up and down direction on which the upper emission window 172f is formed. The absorption filter 172d is provided in the lower emission window 172g. The absorption filter 172d is an optical member that selectively transmits fluorescence in a predetermined wavelength band among fluorescence collected by the objective lens 121 at the time of fluorescence observation.

A multi-dichroic mirror 172c′ that transmits fluorescence in a plurality of wavelength bands may be provided as the dichroic mirror 172c inside the frame 172a. The dichroic mirror 172c is fixed to the frame 172a in a state of being inclined by a predetermined angle with respect to the Z direction. The excitation light transmitted through the excitation filter 172b provided in the entrance window 172e is reflected upward by the dichroic mirror 172c, passes through the upper emission window 172f, and is emitted upward from the frame 172a. The excitation light having passed through the upper emission window 172f passes through the objective lens 121 and is applied to the observation target B on the stage S.

Since the plurality of filter cubes 172 is attached to the filter turret 173, by rotating the filter turret 173, the filter cube 172 used at the time of fluorescence observation can be switched to arbitrary one filter cube 172 among the plurality of filter cubes 172. The filter turret 173 is a member in which the plurality of excitation filters 172b, the plurality of dichroic mirrors 172c, and the plurality of absorption filters 172d are rotatably disposed about the support shaft 174 extending in the vertical direction and that switches the excitation filters 172b, the dichroic mirrors 172c, and the absorption filters 172d disposed on the observation optical path.

One set is formed by the excitation filter 172b, the dichroic mirror 172c, and the absorption filter 172d provided in one filter cube 172. The excitation filter 172b, the dichroic mirror 172c, and the absorption filter 172d provided in each filter cube 172 are different so as to correspond to the fluorescent reagent used at the time of fluorescence observation. In a case where, for example, GFP, TexasRed, DAPI, or the like is used as the fluorescent reagent, the filter cube 172 corresponding to GFP, TexasRed, DAPI, or the like is attached to the filter turret 173.

The excitation filter 172b of the filter cube 172 corresponding to GFP allows light having a wavelength of around 490 nm to pass, and the absorption filter 172d allows light having a wavelength of around 78510 nm to pass. The dichroic mirror 172c reflects light having a wavelength of around 490 nm and allows light having a wavelength of around 510 nm to pass therethrough.

Furthermore, the excitation filter 172b of the filter cube 172 corresponding to the TexasRed allows light having a wavelength of around 596 nm to pass therethrough, and the absorption filter 172d allows light having a wavelength of around 620 nm to pass therethrough. The dichroic mirror 172c reflects light having a wavelength of around 596 nm and allows light having a wavelength of around 620 nm to pass therethrough.

Furthermore, the excitation filter 172b of the filter cube 172 corresponding to the DAPI allows light having a wavelength of around 345 nm to pass therethrough, and the absorption filter 172d allows light having a wavelength of around 455 nm to pass therethrough. The dichroic mirror 172c reflects light having a wavelength of around 345 nm and allows light having a wavelength of around 455 nm to pass therethrough.

An emission filter unit 180 as illustrated in FIG. 9 is provided below the filter turret 173, that is, below the dichroic mirror 172c. The emission filter unit 180 includes a plurality of emission filters 181, a filter wheel 182 to which the plurality of emission filters 181 is detachably attached, and a wheel drive motor 183. Although not illustrated, the wheel drive motor 183 transmits a rotational force to the filter wheel 182 via, for example, a gear.

The plurality of emission filters 181 is disposed at intervals in the circumferential direction of the filter wheel 182. By rotating the filter wheel 182, arbitrary one emission filter 181 of the plurality of emission filters 181 can be disposed on the optical path L2 of fluorescence. The filter wheel 182 is provided with a notch 182b to which the emission filter 181 is not attached. The notch 182b is a part through which the light transmitted through the observation target B passes at the time of transmission observation, and the filter wheel 182 is rotated so that the notch 182b is disposed on the optical path L3 of the light transmitted through the observation target B at the time of transmission observation.

The emission filter 181 is a member for selectively transmitting fluorescence in a specific wavelength band. That is, the plurality of emission filters 181 functions as a multi-filter that transmits fluorescence in a plurality of wavelength bands by sequentially switching the absorption filters disposed on the optical path L2 of fluorescence. For example, the wavelength band of the received fluorescence can be changed by fixing the filter turret 173 in which the multi-band dichroic mirror 172c that transmits fluorescence of a plurality of wavelength bands is disposed and rotating the filter wheel 182 to sequentially switch the emission filter 181.

As illustrated in FIGS. 2 and 3, the microscope body 1 includes a transmitted illumination section 200 that irradiates the observation target B placed on the stage S with observation light. The transmitted illumination section 200 includes a transmitted illumination body 210. The transmitted illumination body 210 includes a transmitted illumination housing 211, and the transmitted illumination housing 211 has a cylindrical shape elongated in the front-rear direction.

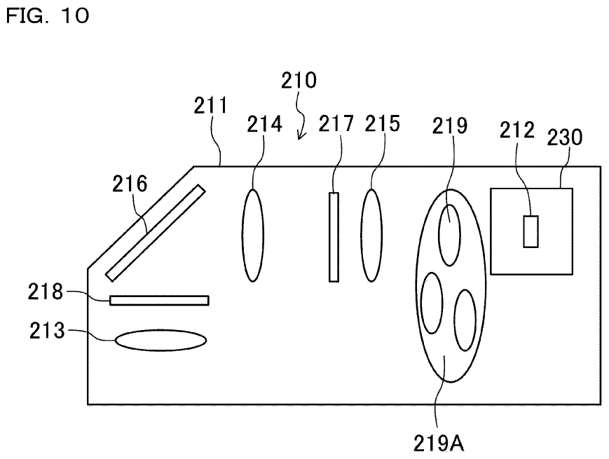

As illustrated in FIG. 10, the transmitted illumination body 210 includes a white light source 212 that emits transmitted illumination light that is illumination light for transmission observation, a filter 219, a condenser lens 213, a relay lens 214, and an illumination lens 215. Here, the filter 219 may be a plurality of filters having transmission bands of a red band, a green band, and a blue band. In this case, each filter is attached to the wheel 219A, and the wavelength with which the observation target B is irradiated can be switched by rotating the wheel 219A. Furthermore, the filter 219 may be an optical element capable of electrically switching the transmission band.

As illustrated in FIG. 10, the illumination lens 215 is disposed in front of a light source accommodation portion 230. Therefore, red light, green light, and blue light sequentially generated by being emitted from the white light source 212 and being transmitted through the filter 219 are incident on the illumination lens 215. The illumination lens 215 is a member for collecting light of different wavelengths sequentially generated by being emitted from the white light source 212 and being transmitted through the filter 219.

The relay lens 214 is a member disposed between the condenser lens 213 and the white light source 212 and having a focal plane at an aperture diaphragm of the condenser lens 213 and a rear focal position of the illumination lens 215. The optical axis of the relay lens 214 and the optical axis of the illumination lens 215 are both oriented in the front-rear direction and coincide with each other.

The transmitted illumination body 210 includes a mirror 216. The mirror 216 is provided in a front portion of the transmitted illumination housing 211. The light emitted forward from the relay lens 214 is incident on the mirror 216 and is reflected downward by the mirror 216.

The condenser lens 213 is a member that is disposed below the mirror 216, collects the light emitted from the white light source 212, and irradiates the observation target B placed on the stage S with transmitted illumination light. The optical axis of the condenser lens 213 is directed in the up and down direction, and the light reflected downward by the mirror 216 is incident on the condenser lens 213 and then exits downward from the condenser lens 213. In such an optical system, the illumination lens 215 is designed to focus the light from the white light source 212 at a position conjugate with the aperture diaphragm position of the relay lens 214.

A first light diffusion plate 217 as a first light homogenizing element is provided at a rear focal position of the illumination lens 215. Moreover, a second light diffusion plate 218 as a second light homogenizing element is provided at the position of the aperture diaphragm of the condenser lens 213. Since the first light diffusion plate 217 and the second light diffusion plate 218 are provided on the optical path of the transmitted illumination light, light beams can be scattered and mixed. Therefore, unevenness of the light emitted from the condenser lens 213 is eliminated, and the light can be brought close to uniform light.

The optical path L3 (illustrated in FIG. 3) of the transmitted light partially overlaps with the optical path L1 of the excitation light. That is, the excitation light is emitted from below to above the stage S. A part of the excitation light transmitted through the observation target B is incident on the condenser lens 213 of the transmitted illumination section 200.

The microscope body 1 includes an imaging module 150. The imaging module 150 is accommodated in the base housing 100 and is provided below the lower frame 104. The imaging module 150 is disposed on the optical path L2 of the fluorescence collected by the optical module 120 and detects the fluorescence collected by the optical module 120, and is disposed on the optical path L3 of the light transmitted through the observation target B and detects the light transmitted through the observation target B. In the present embodiment, the imaging module 150 is provided below the optical module 120.

The imaging module 150 includes a camera 151 and an imaging lens 152. The camera 151 is, for example, a complementary metal oxide semiconductor (CMOS) image sensor including an imaging element. The imaging element is, for example, a monochrome CMOS, and the camera 151 includes a monochrome camera including a monochrome CMOS. The imaging element may be another imaging element such as a charge coupled device (CCD) image sensor.

Fluorescence or transmitted light incident on the imaging module 150 is collected and imaged by the imaging lens 152, and then detected (received) by the camera 151. Therefore, an image of the observation target B is obtained. An analog electric signal (Hereinafter, referred to as a light reception signal.) corresponding to the amount of received light is output from each pixel of the imaging element of the camera 151 to a control board 160. The camera 151 is an example of a detection section that detects light collected by the objective lens 121 constituting the observation optical system.

Unlike the color CCD, the monochrome CCD constituting the camera 151 of the present embodiment does not need to be provided with a pixel that receives light of a red wavelength, a pixel that receives light of a green wavelength, and a pixel that receives light of a blue wavelength. Therefore, the measurement resolution of the monochrome CCD is higher than the resolution of the color CCD. Furthermore, unlike the color CCD, the monochrome CCD does not need to include a color filter in each pixel. Therefore, the sensitivity of the monochrome CCD is higher than the sensitivity of the color CCD. For these reasons, the camera 151 according to the present embodiment includes a monochrome CCD.

An analog/digital converter (A/D converter), a first in first out (FIFO) memory, and the like (not illustrated) are mounted on the control board 160. The light reception signal output from the camera 151 is sampled at a constant sampling period by the A/D converter and converted into a digital signal on the basis of the control of the electronic computer 2 illustrated in FIG. 1. The digital signals output from the A/D converter are sequentially accumulated in the FIFO memory. The digital signals accumulated in the FIFO memory are sequentially transferred to the electronic computer 2 as pixel data.

As illustrated in FIG. 1, the electronic computer 2 includes, for example, a desktop personal computer or a notebook personal computer, and includes a computer body 20, a display section 21, and an operation section 22. The computer body 20 includes a central processing unit (CPU), a read only memory (ROM), a random access memory (RAM), a storage device, and the like. The ROM stores a system program. The RAM stores various data and functions as a work region of the CPU. The storage device includes a solid state drive, a hard disk drive, or the like.

The storage device stores a control program and an image processing program of the fluorescence microscope A. On the basis of the control program and the image processing program, the computer body 20 controls each part of the microscope body 1 and controls the light source unit 3. Furthermore, the storage device is also used to store various data such as image data output from the imaging module 150.

The display section 21 includes, for example, an LCD panel, an organic electroluminescence (EL) panel, or the like. On the display section 21, a user interface screen for performing various settings of the fluorescence microscope A is displayed, and an observation image or the like based on the image data output from the imaging module 150 is displayed.

The operation section 22 includes a member for operating the computer body 20.

Examples of the member constituting the operation section 22 include a keyboard and a pointing device. Examples of the pointing device include a mouse and a joystick.

The computer body 20 controls each part of the microscope body 1, so that fluorescence observation using fluorescence can be performed and transmission observation can also be performed. At the time of fluorescence observation, the filter switching device 171 operates and switches to the filter cube 172 corresponding to the fluorescent reagent to be used. Furthermore, the objective lens is switched to a desired objective lens 121 by the revolver drive device 123. Moreover, in a case where the emission filter 181 is used, the emission filter unit 180 operates and is switched to a desired emission filter 181.

The light source unit 3 generates excitation light. The excitation light generated by the light source unit 3 is transmitted to the microscope body 1 via the fiber cable 6, transmitted through the filter cube 172 and the objective lens 121, and then applied to the observation target B. At the time of observation, the Z-drive module 140 operates, and focus adjustment is automatically executed.

The fluorescence generated in the observation target B is incident on the objective lens 121, then is transmitted through the filter cube 172 and the emission filter 181, and is incident on the imaging module 150. The fluorescence incident on the imaging module 150 is received by the camera 151. The analog electric signal corresponding to the amount of received light is output from the control board 160 to the computer body 20 to generate image data, and a fluorescence image is displayed on the display section 21.

At the time of transmission observation, the observation target B is irradiated with the transmitted light emitted from the transmitted illumination section 200. In the transmission observation, the filter switching device 171 operates, and the filter cube 172 is not disposed on the optical path L3 of the transmitted light. Furthermore, the objective lens is switched to a desired objective lens 121 by the revolver drive device 123. Moreover, the emission filter unit 180 operates, and the emission filter 181 is not disposed on the optical path L3 of the transmitted light. Also at the time of transmission observation, the Z-drive module 140 operates, and focus adjustment is automatically executed. At the time of transmission observation, the camera 151 can receive the transmitted light transmitted through the observation target B in a state where the absorption filter 172d is disposed outside the observation optical path by the filter turret 173.

Specifically, the transmitted light transmitted through the observation target B is incident on the objective lens 121, and then is incident on the imaging module 150 without being transmitted through the filter cube 172 and the emission filter 181. The transmitted light incident on the imaging module 150 is received by the camera 151. The analog electric signal corresponding to the amount of received light is output from the control board 160 to the computer body 20 to generate image data, and the image data is displayed on the display section 21.

The fluorescence microscope A of the present embodiment has a color observation function of generating a color image of the observation target B without using a color image generation filter applied at the time of conventional color image generation. The color observation function of the fluorescence microscope A can be realized by the white light source 212, the filter 219, and the transmitted illumination control section 23 and the image processing section 24 illustrated in FIG. 2.

The transmitted illumination control section 23 controls the white light source 212 of the transmitted illumination section 200 to emit light. Furthermore, the transmitted illumination control section 23 sequentially switches, in a time division manner, the wavelength of the light with which the observation target B is irradiated by driving the wheel 219A holding the filter 219. Specifically, the transmitted illumination control section 23 drives the wheel 219A holding the filter 219 so as to transmit only the light of the first wavelength, thereby irradiating the observation target B with the red light. Furthermore, the transmitted illumination control section 23 drives the wheel 219A holding the filter 219 so as to transmit only the light of the second wavelength, thereby irradiating the observation target B with the green light. Moreover, the transmitted illumination control section 23 drives the wheel 219A holding the filter 219 so as to transmit only the light of the third wavelength, thereby irradiating the observation target B with blue light. As described above, the transmitted illumination control section 23 drives the wheel 219A holding the filter 219 to sequentially switch, in a time division manner, the wavelength of the light with which the observation target B is irradiated, and controls the transmitted illumination section 200 so as to emit light having wavelengths different from each other. Here, although not illustrated, in a case where an optical element capable of electrically switching the transmission band is used as the filter, the transmitted illumination control section 23 irradiates the observation target B with red light by driving the filter to transmit only light of the first wavelength. Furthermore, the transmitted illumination control section 23 drives the filter so as to transmit only the light of the second wavelength, thereby irradiating the observation target B with the green light. Moreover, the transmitted illumination control section 23 drives the filter so as to transmit only the light of the third wavelength, thereby irradiating the observation target B with blue light. As described above, the transmitted illumination control section 23 drives the wheel 219A on which the filter 219 is held or the filter using the optical element capable of electrically switching the transmission band, thereby sequentially switching, in a time division manner, the wavelength of the light with which the observation target B is irradiated, and controlling the transmitted illumination section 200 so as to emit light having wavelengths different from each other. Note that the order of red light irradiation, blue light irradiation, and green light irradiation is not particularly limited.

In the case of red light irradiation, the red light transmitted through the observation target B is received by the camera 151. Thereafter, when blue light irradiation is performed, the blue light transmitted through the observation target B is received by the camera 151.

Thereafter, when green light irradiation is performed, the green light transmitted through the observation target B is received by the camera 151. In this manner, the camera 151 sequentially receives transmitted light of different wavelengths transmitted through the observation target B.

The image processing section 24 is a part that generates a color image that is an observation image on the basis of transmitted light of different wavelengths sequentially received by the camera 151. That is, an analog electrical signal corresponding to the amount of received red light when the red light transmitted through the observation target B is received by the camera 151, an analog electrical signal corresponding to the amount of received blue light when the blue light transmitted through the observation target B is received by the camera 151, and an analog electrical signal corresponding to the amount of received green light when the green light transmitted through the observation target B is received by the camera 151 are transmitted to the image processing section 24. The image processing section 24 synthesizes three monochrome images generated by the received three analog electrical signals to generate a color image.

Next, a case of generating a monochrome image will be described. In a case of generating a monochrome image, the transmitted illumination control section 23 turns on the white light source 212 and irradiates the observation target B with white light. Furthermore, the transmitted illumination control section 23 transmits the white light emitted from the white light source 212 by rotating the wheel 219A having an empty hole in which the filter 219 is not disposed and driving the wheel 219A such that the empty hole is disposed on the optical path. Furthermore, in the case of a filter that electrically switches the transmission band, a mechanism that inserts and removes the filter onto and from the optical path may be further provided, and the observation target B may be irradiated with white light emitted from the white light source 212 by driving the filter to be removed from the optical path. The image processing section 24 generates a monochrome image on the basis of transmitted light of white light received by the camera 151.

### (Control of User Interface Screen and Each Section)

As illustrated in FIG. 2, the fluorescence microscope A includes a display control section 60, a reception section 61, an observation condition setting section 62, an image acquisition section 63, a lens selection section 64, a channel selection section 65, a coordinate specification section 66, an observation condition reproduction section 67, an overlap determination section 68, and a navigation data creation section 69 as parts that execute generation of various user interface screens, display control of various user interface screens, and control of each section.

The display control section 60, the reception section 61, the observation condition setting section 62, the image acquisition section 63, the lens selection section 64, the channel selection section 65, the coordinate specification section 66, the observation condition reproduction section 67, the overlap determination section 68, and the navigation data creation section 69 can be configured by the computer body 20 of the electronic computer 2. For example, the display control section 60, the reception section 61, the observation condition setting section 62, the image acquisition section 63, the lens selection section 64, the channel selection section 65, the coordinate specification section 66, the observation condition reproduction section 67, the overlap determination section 68, and the navigation data creation section 69 can be configured by a combination of hardware of the computer body 20 and a program executed by the computer body 20.

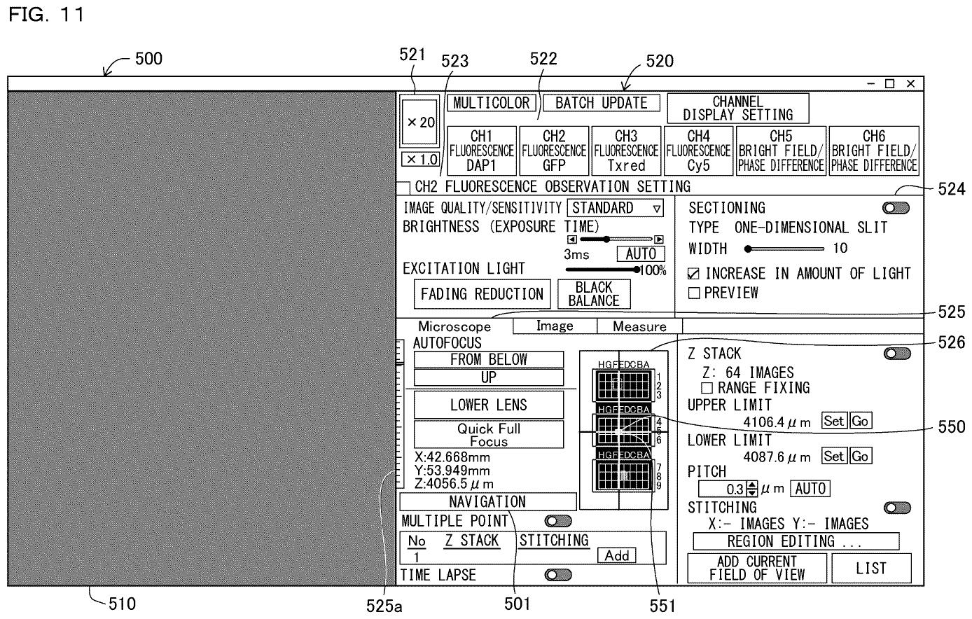

The display control section 60 is a part that generates various user interface screens and displays the screens on the display section 21. FIG. 11 is a diagram illustrating an example of the display screen 500 displayed on the display section 21 by the display control section 60. The display screen 500 is provided with a live view display region 510 and a setting region 520. In the live view display region 510, the current observation target B acquired by the imaging module 150 is displayed in a live view format.

The setting region 520 is provided with a lens selection region 521, a channel selection region 522, an observation setting region 523, an imaging setting region 524, a height setting user interface screen 525, and a positioning user interface screen 526.

In the lens selection region 521, the objective lens 121 can be selected. Specifically, in a case where the objective lenses 121 having a plurality of different magnifications are attached to the revolver 122, information regarding the objective lenses 121 having the plurality of different magnifications is displayed in the lens selection region 521, and the user operates the lens selection region 521, so that the objective lens 121 having a magnification to be used for observation can be selected from among a plurality of the objective lenses 121. The information regarding the objective lenses 121 is, for example, a magnification, a type of a corresponding fluorescent reagent, an observation type (bright field observation, dark field observation, phase difference observation, differential interference observation, fluorescence observation), and the like.

The lens selection section 64 illustrated in FIG. 2 is a part that selects the magnification of the objective lens 121. For example, the lens selection section 64 selects the objective lens 121 having the magnification selected by the user in the lens selection region 521 illustrated in FIG. 11.

In the channel selection region 522 illustrated in FIG. 11, dark field observation and phase difference observation can be selected, and a color channel at the time of fluorescence observation can be selected. The color channels at the time of fluorescence observation include color channels corresponding to “GFP”, “TexasRed”, “DAPI”, and the like of the fluorescence reagent used at the time of fluorescence observation, and the user can select a desired color channel by operating the channel selection region 522.

The channel selection section 65 illustrated in FIG. 2 is a part that selects a color channel at the time of fluorescence observation. For example, the channel selection section 65 selects a color channel selected by the user in the channel selection region 522 illustrated in FIG. 11.

The observation condition setting section 62 illustrated in FIG. 2 is a part for setting an observation condition of the observation optical system. For example, the magnification and the like of the objective lens 121 having the magnification selected by the user in the lens selection region 521 illustrated in FIG. 11 is included in the observation condition of the observation optical system. Therefore, the observation condition setting section 62 sets the observation condition on the basis of the information of the objective lens 121 of the magnification selected by the user in the lens selection region 521.

In the observation setting region 523, for example, it is possible to set the image quality of the observation image, the sensitivity when acquiring the observation image, the brightness (exposure time), the excitation light at the time of fluorescence observation, and the like.

Furthermore, in the imaging setting region 524, various imaging settings are possible.

The image acquisition section 63 is a part that acquires the observation image generated by the image processing section 24 as an individual navigation image on the basis of an image acquisition instruction from the user. The image acquisition instruction is made, for example, by the user operating a navigation button 501 provided on the display screen 500 illustrated in FIG. 11.

The positioning user interface screen 526 illustrated in FIG. 11 is a screen for the user to designate the observation position of the observation target B on the map image of the stage S on which the observation target B is placed. The positioning user interface screen 526 is provided with an individual navigation image display region 526a that displays the individual navigation image acquired by the image acquisition section 63. The display control section 60 displays a wide area image as a map image on the positioning user interface screen 526. The wide area image is an image obtained by capturing an image of a wide range of the observation target B, and specifically, an image in a range wider than a range displayed in the live view display region 510 can be the wide area image. The fluorescence image output from the imaging module 150 is used as the wide area image.

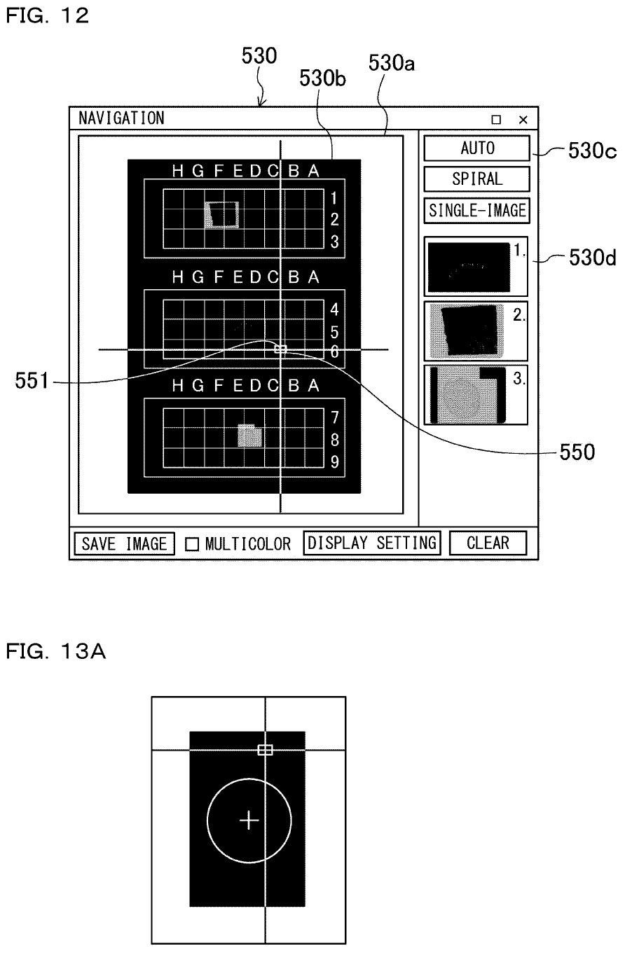

FIG. 12 illustrates an enlarged positioning user interface screen 530 obtained by enlarging the positioning user interface screen 526. The display control section 60 causes the display section 21 to display the enlarged positioning user interface screen 530 obtained by enlarging the positioning user interface screen 526 in a window different from the positioning user interface screen 526.

The enlarged positioning user interface screen 530 is provided with an individual navigation image display region 530a that displays the individual navigation image acquired by the image acquisition section 63. Furthermore, a thumbnail image display region 530d that displays a thumbnail image of the individual navigation image acquired by the image acquisition section 63 is also provided in the enlarged positioning user interface screen 530.

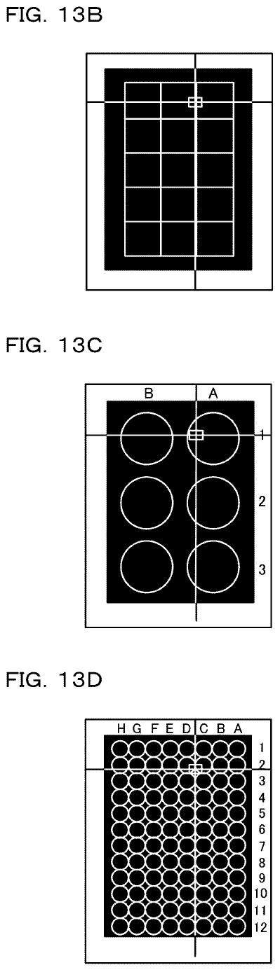

The display control section 60 superimposes and displays the stage guide 530b on the wide area image displayed in the individual navigation image display region 530a. The stage guide 530b is for presenting, to the user, a shape, a size, and the like of a part where the observation target B is placed. The type of the stage guide 530b is not particularly limited. The stage guide 530b includes a circular holder guide illustrated in FIG. 13A, a rectangular holder guide illustrated in FIG. 13B, a 6-hole multi-well guide illustrated in FIG. 13C, a 96-hole multi-well guide illustrated in FIG. 13D, and the like. These stage guides 530b can be stored in a storage section 70 (illustrated in FIG. 1) included in the electronic computer 2. The storage section 70 includes, for example, a solid state drive, a hard disk drive, or the like. The storage section 70 may be installed in a place different from the place where the microscope body 1 is installed.

The display control section 60 displays the stage guide 530b selected by the reception section 61 from among the plurality of stage guides 530b of different types stored in the storage section 70. The stage guide 530b may be selected according to the stage S, and is displayed in the individual navigation image display region 530a as illustrated in FIG. 12. For example, when the user performs a selection operation of the stage guide 530b, the display control section 60 displays the stage guide 530b selected by the user.

The display control section 60 is configured to be switchable between display and non-display of the stage guide 530b. For example, a display button, a non-display button, and the like of the stage guide 530b are provided on the enlarged positioning user interface screen 530, and when the display control section 60 detects that the user has operated the display button, the stage guide 530b is displayed in the individual navigation image display region 530a. On the other hand, when the display control section 60 detects that the user has operated the non-display button, the stage guide 530b is not displayed. That is, the stage guide 530b can be displayed or cannot be displayed according to the request of the user.

The enlarged positioning user interface screen 530 is provided with an image acquisition instruction button 530c for selecting an imaging method and giving an image acquisition instruction. The image acquisition instruction button 530c includes an auto button that automatically captures an image by the image acquisition section 63, a spiral button that captures an image in a spiral pattern from the center of the field of view of the camera 151 toward the outside, and a single-image button that captures only one image.

The display control section 60 superimposes and displays the individual navigation image on the enlarged positioning user interface screen 530. The enlarged positioning user interface screen 530 on which the individual navigation image is superimposed is a screen that can be used as a navigation screen for the user to grasp the observation position.

As illustrated in FIG. 11, the display control section 60 can generate a navigation screen in which the individual navigation image acquired by the image acquisition section 63 is superimposed and displayed on the positioning user interface screen 526, and can display the generated navigation screen on the display section 21. At this time, the display control section 60 displays the individual navigation image acquired by the image acquisition section 63 on the positioning user interface screen 526.

The height setting user interface screen 525 is a screen for receiving adjustment of the observation height of the observation target B while displaying, in the live view display region 510, the image of the observation target B at the observation position designated by the positioning user interface screen 526. The height setting user interface screen 525 includes a scale 525a for displaying the observation height, and the user can operate the operation section 22 while viewing the scale 525a to designate a desired observation height. Furthermore, the user can operate the operation section 22 while viewing the live view image to designate a desired observation height.

The coordinate specification section 66 illustrated in FIG. 2 specifies the stage coordinates of the observation position on the basis of the image acquisition instruction. For example, the coordinate specification section 66 specifies the observation height when the image acquisition instruction is received.

The reception section 61 illustrated in FIG. 2 is a part that detects user's operation performed on various screens displayed on the display section 21 by the display control section 60. The user's operation is performed by the operation section 22. Specifically, the reception section 61 is a part that receives the setting of the observation position on the positioning user interface screen 526 displayed on the display section 21 by the display control section 60 and receives the setting of the observation height on the height setting user interface screen 525 displayed on the display section 21 by the display control section 60.

When the reception section 61 receives the setting of the observation position on the positioning user interface screen 526, the XY driving device (first drive section) 105 drives the stage S to the observation position set by the reception section 61. Furthermore, when the reception section 61 receives the setting of the observation height on the height setting user interface screen 525, the Z-drive module (second drive section) 140 drives the stage S to the observation height set by the reception section 61.

The display control section 60 displays an icon 551 indicating the observation position received by the reception section 61 on both the positioning user interface screen 526 illustrated in FIG. 11 and the enlarged positioning user interface screen 530 illustrated in FIG. 12. The icon 551 can be rectangular or +-shaped, for example, but is not limited thereto.

When the user operates the operation section 22 to update the observation position, the reception section 61 receives the update of the observation position. According to the update of the observation position received by the reception section 61, the display control section 60 updates the display of the icon 551 indicating the observation position on the positioning user interface screen 526 and the enlarged positioning user interface screen 530 in conjunction with each other.

The display control section 60 superimposes and displays a rectangular frame 550 indicating a field of view range on the positioning user interface screen 526 and the enlarged positioning user interface screen 530. At this time, the display control section 60 acquires information regarding the magnification of the objective lens 121 selected by the lens selection section 64, and changes the size of the rectangular frame 550 on the basis of the acquired magnification of the objective lens 121. For example, the larger the magnification of objective lens 121 is, the smaller the size of rectangular frame 550 becomes.

The individual navigation image may be a pseudo color image. That is, the image processing section 24 acquires the color channel selected by the channel selection section 65. The image processing section 24 generates a pseudo color image on the basis of the acquired color channel. In this case, the display control section 60 displays the pseudo color image generated by the image processing section 24 on the positioning user interface screen 526 and the enlarged positioning user interface screen 530 as individual navigation images.

When the individual navigation image is displayed, the display position can be determined using the stage coordinates of the observation position. Since the coordinate specification section 66 can specify the stage coordinates of the observation position, the display control section 60 can acquire the stage coordinates specified by the coordinate specification section 66. The display control section 60 superimposes and displays the individual navigation image at the corresponding observation position on the positioning user interface screen 526 and the enlarged positioning user interface screen 530 on the basis of the stage coordinates specified by the coordinate specification section 66.

When receiving the selection of the individual navigation image displayed on the positioning user interface screen 526 by the reception section 61, the XY driving device 105 moves the stage S to the observation position made to correspond to the received individual navigation image. Therefore, the user can observe a desired position only by selecting the individual navigation image. Furthermore, when receiving the selection of the individual navigation image displayed on the positioning user interface screen 526 by the reception section 61, the Z-drive module 140 moves the stage S to the observation height made to correspond to the received individual navigation image.

As displayed in the individual navigation image display region 530a illustrated in FIG. 12, the image acquisition section 63 can acquire a plurality of the individual navigation images. For example, the image acquisition section 63 acquires the first individual navigation image (the uppermost image in the individual navigation image display region 530a) on the basis of the first image acquisition instruction, and acquires the second individual navigation image (the image at the center in the up and down direction of the individual navigation image display region 530a) on the basis of the second image acquisition instruction. In this case, the coordinate specification section 66 specifies the first observation position when the first image acquisition instruction is received, and specifies the second observation position when the second image acquisition instruction is received. Then, the display control section 60 superimposes and displays the first individual navigation image on the corresponding observation position on the enlarged positioning user interface screen 530 on the basis of the first observation position specified by the coordinate specification section 66, and superimposes and displays the second individual navigation image on the corresponding observation position on the enlarged positioning user interface screen 530 on the basis of the second observation position specified by the coordinate specification section 66. The display control section 60 arranges and displays the first individual navigation image and the second individual navigation image on the individual positioning user interface screen 530d.

In the example illustrated in FIG. 12, the first individual navigation image and the second individual navigation image are displayed side by side in the up and down direction on the individual positioning user interface screen 530d, but the present invention is not limited thereto, and the first individual navigation image and the second individual navigation image may be displayed side by side in the left-right direction. Furthermore, the image acquisition section 63 may acquire the third individual navigation image (the lowermost image in the individual navigation image display region 530a) on the basis of the third image acquisition instruction. In this case, the coordinate specification section 66 specifies the third observation position when the third image acquisition instruction is received, and superimposes and displays the third individual navigation image on the corresponding observation position on the enlarged positioning user interface screen 530 on the basis of the third observation position specified by the coordinate specification section 66. Furthermore, the display control section may display the first individual navigation image, the second individual navigation image, and the third individual navigation image on the individual positioning user interface screen 530d side by side in the up and down direction. As described above, the number of individual navigation images is not particularly limited, and may be one or more.

The first observation position and the first observation height specified by the coordinate specification section 66 are associated with the first individual navigation image acquired by the image acquisition section 63. Furthermore, the second observation position and the second observation height specified by the coordinate specification section 66 are associated with the second individual navigation image acquired by the image acquisition section 63. The same applies to the third individual navigation image.

The user can select any one individual navigation image from among the plurality of individual navigation images displayed on the individual positioning user interface screen 530d by operating the operation section 22. The individual navigation image selected by the user is received by the reception section 61.

That is, when the reception section 61 receives the selection of the first individual navigation image from among the plurality of individual navigation images displayed on the individual positioning user interface screen 530d, the XY driving device 105 and the Z-drive module 140 are controlled on the basis of the first observation position and the first observation height made to correspond to the first individual navigation image.

On the other hand, when the reception section 61 receives the selection of the second individual navigation image from among the plurality of individual navigation images displayed on the individual positioning user interface screen 530d, the XY driving device 105 and the Z-drive module 140 are controlled on the basis of the second observation position and the second observation height made to correspond to the second individual navigation image. Therefore, the user can observe the observation target B at a desired observation position and observation height only by performing an operation of selecting an individual navigation image from among the plurality of individual navigation images displayed on the individual positioning user interface screen 530d.

The navigation data creation section 69 associates the individual navigation image with, for example, observation conditions and the like, and stores the individual navigation image and the observation conditions and the like associated therewith in the storage section 70 included in the electronic computer 2. The observation condition reproduction section 67 acquires the navigation data created by the navigation data creation section 69. The observation condition reproduction section 67 may reproduce the observation condition on the basis of the observation condition associated with the navigation data created by the navigation data creation section 69.

When the selection of the first individual navigation image from among the plurality of individual navigation images displayed on the individual positioning user interface screen 530d is received by the reception section 61, the observation condition reproduction section 67 reproduces the observation condition associated with the first individual navigation image. On the other hand, when the selection of the second individual navigation image from among the plurality of individual navigation images displayed on the individual positioning user interface screen 530d is received by the reception section 61, the observation condition reproduction section 67 reproduces the observation condition associated with the second individual navigation image. The same applies to the third individual navigation image.

The overlap determination section 68 illustrated in FIG. 2 is a part that acquires the first individual navigation image and the second individual navigation image and determines whether or not there is an overlap in the field of view ranges between the first individual navigation image and the second individual navigation image. In a case where the overlap determination section 68 determines that there is an overlap in the field of view ranges of the first individual navigation image and the second individual navigation image and the reception section 61 receives the selection of the first individual navigation image and then receives the selection of the second individual navigation image, the display control section 60 superimposes and displays the second individual navigation image on the first individual navigation image.

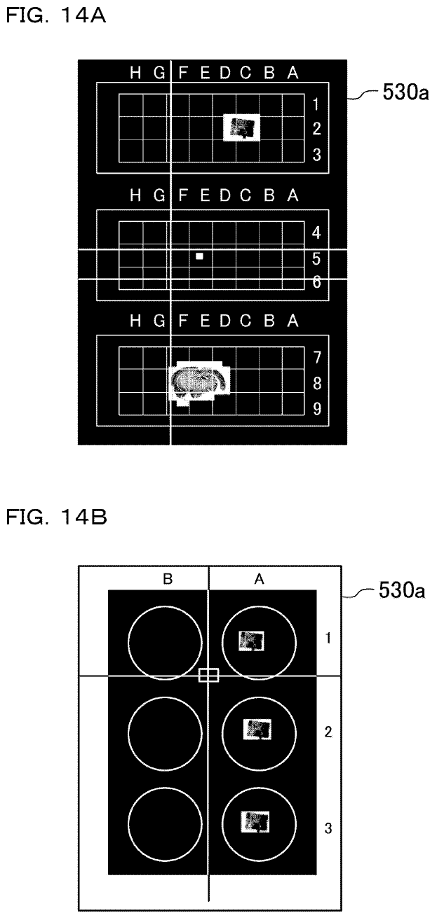

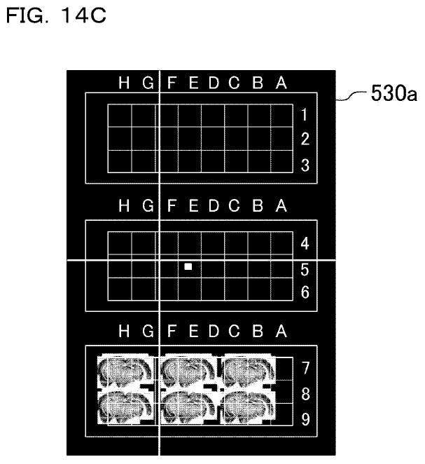

Hereinafter, the navigation function according to the present embodiment will be described in detail with reference to specific examples. FIG. 14A illustrates an individual navigation image display region 530a in a case where a different observation target B is observed. In this case, a plurality of individual navigation images of different observation targets B is displayed in the individual navigation image display region 530a. When the individual navigation image is acquired, first, after the first observation target B is placed on the stage S, the field of view is searched and focused, and the user gives an instruction to acquire an image of the navigation image and observes the navigation image. Thereafter, after the second observation target B is placed on the stage S, the field of view is searched and focused, and the user gives an image acquisition instruction of the navigation image and observes the navigation image. This is repeated for each observation target B.

FIG. 14B illustrates an individual navigation image display region 530a in a case where a plurality of the same observation targets B is observed. In this case, individual navigation images of a plurality of the same observation targets B are displayed in the individual navigation image display region 530a. When the individual navigation image is acquired, first, the first observation target B is placed on the stage S, then the field of view is searched and focused, and the user gives an image acquisition instruction of the navigation image. Thereafter, after the second observation target B is placed on the stage S, the field of view is searched and focused, and the user gives an image acquisition instruction of the navigation image. After repeating this for each observation target B, the first observation target B and the second observation target B are observed.

FIG. 14C illustrates the individual navigation image display region 530a in which only one entire navigation image is displayed. In this case, the field of view is searched and focused, and the user issues an image acquisition instruction of the navigation image. Thereafter, a field of view of the first observation target B is moved and observed on the basis of the acquired navigation image, and then a field of view of the second observation target B is moved and observed on the basis of the navigation image. This is repeated.

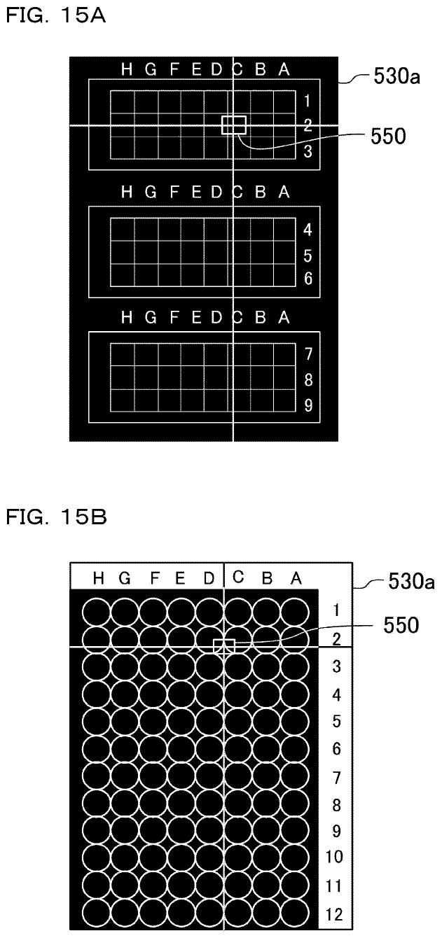

FIG. 15A illustrates a case where an observation position is selected on a rectangular holder guide, and FIG. 15B illustrates a case where an observation position is selected on a multi-well guide. In FIGS. 15A and 15B, the rectangular frame 550 indicating the observation position has a size based on the magnification of the objective lens 121 selected by the lens selection section 64.

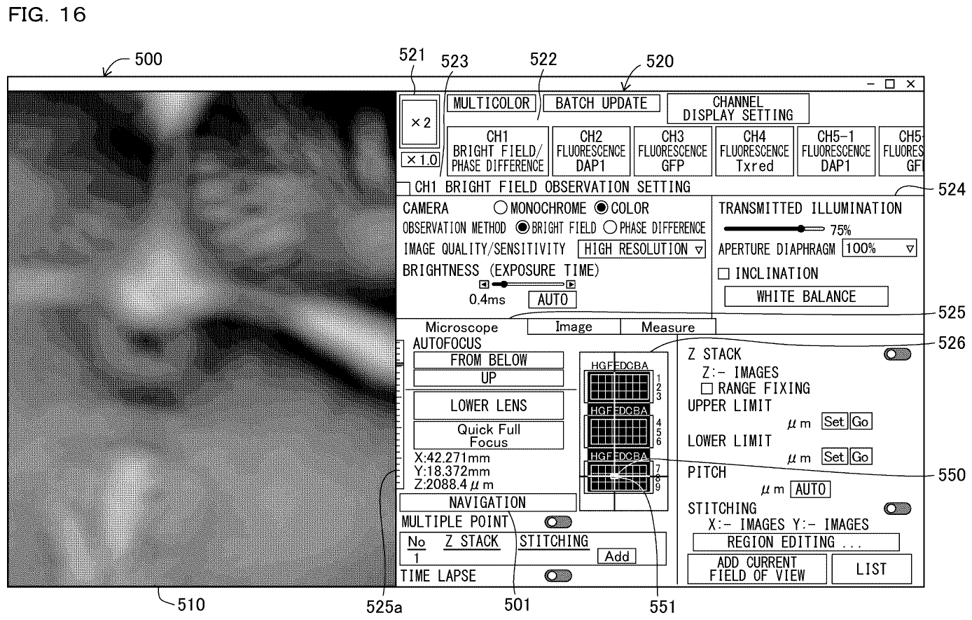

The user performs a click operation using, for example, a mouse or the like such that the position of the rectangular frame 550 becomes an approximate position of the observation target B. This operation is an observation position setting operation performed on the positioning user interface screen 526. At this time, the image acquisition section 63 automatically adjusts the brightness of the image as necessary, and displays the image acquired by the imaging module 150 in the live view display region 510 of the display screen 500 in the live view format. FIG. 16 is a diagram illustrating an example of an image displayed in a live view before focusing.

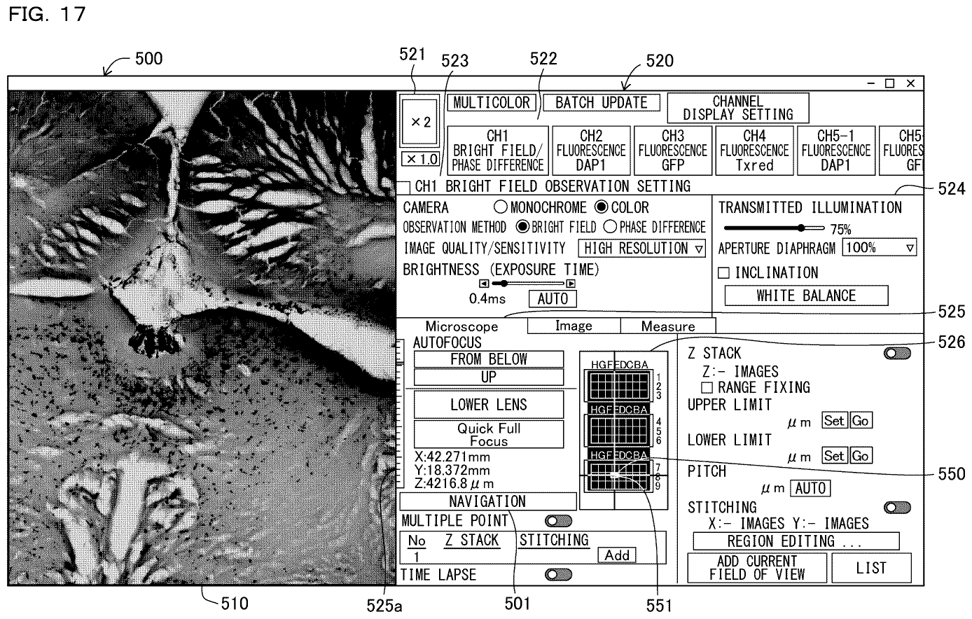

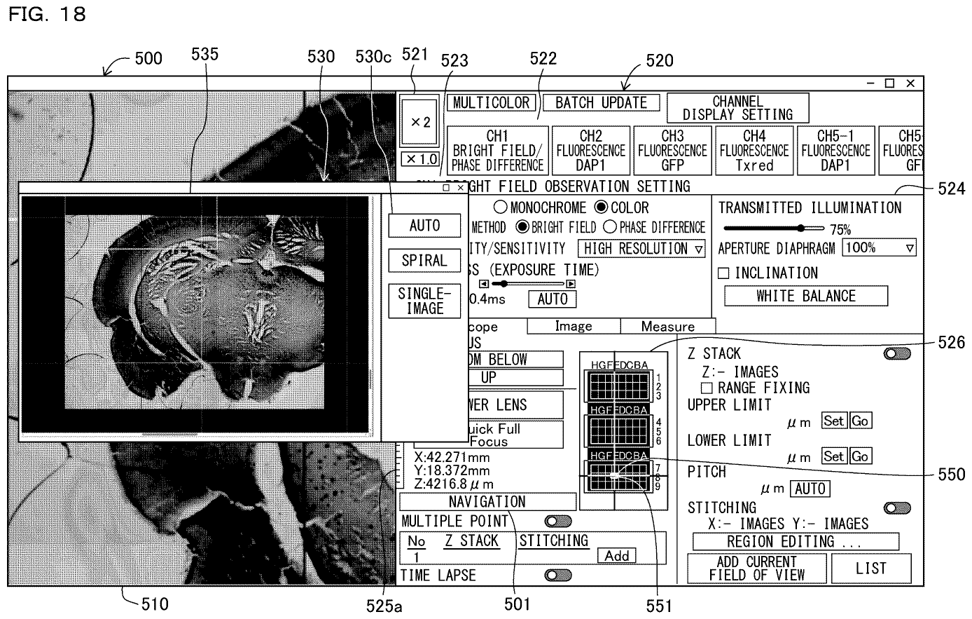

The image acquisition section 63 detects an operation of the operation section 22 by the user and activates the Z-drive module 140 to execute manual focusing or execute automatic focusing by autofocus. FIG. 17 illustrates an example of an image displayed in a live view after focusing.

Thereafter, the user operates the navigation button 501 provided on the display screen 500 illustrated in FIG. 11. Then, the display control section 60 generates the enlarged positioning user interface screen 530 illustrated in FIG. 12 and displays the enlarged positioning user interface screen on the display section 21. When the image acquisition instruction button 530c on the enlarged positioning user interface screen 530 is operated by the user, the image acquisition section 63 acquires an individual navigation image. FIG. 18 illustrates a state in which the individual navigation image acquired by the image acquisition section 63 is displayed in an image display region 535 of the enlarged positioning user interface screen 530. In this manner, the state in which the individual navigation image is acquired is displayed in the image display region 535.

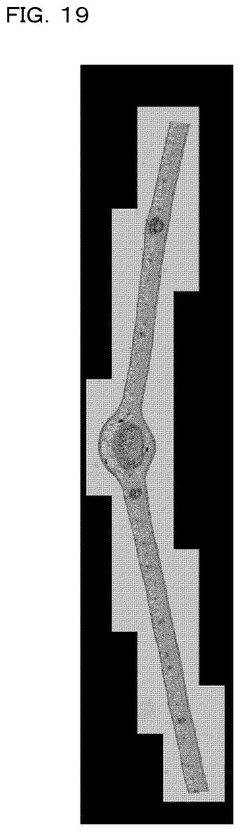

As illustrated in FIG. 19, when the observation target B is elongated, the observation target B may exist only in a part of the stage S. In such a case, the presence or absence of the observation target B is automatically determined by binary imaging on the basis of the image acquired by capturing an image of the observation target B with the imaging module 150, and as a result of the determination, only the range in which the observation target B exists is imaged with the imaging module 150 to acquire the sub-observation image. An individual navigation image can be generated on the basis of the plurality of acquired sub-observation images, and for example, an individual navigation image is obtained by stitching the plurality of acquired sub-observation images.

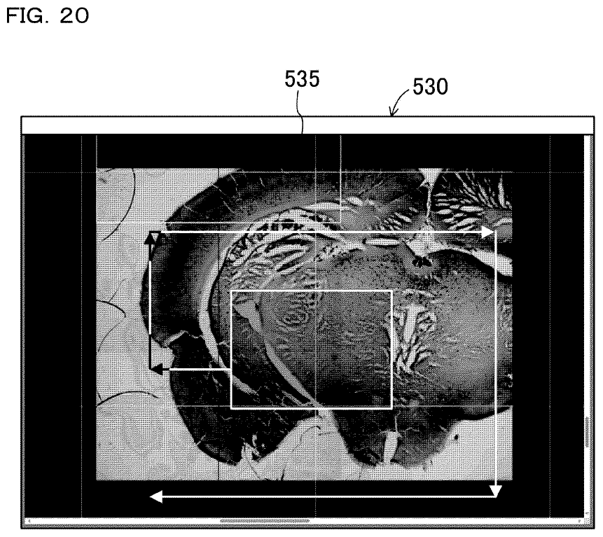

FIG. 20 is a diagram illustrating a case where an image is captured in a spiral pattern to acquire a plurality of sub-observation images in a case where the spiral button is operated among the image acquisition instruction buttons 530c illustrated in FIG. 18. An arrow in FIG. 20 indicates a path for acquiring the sub-observation image, and captures the sub-observation image in a spiral pattern from the center of the field of view toward the outside. In this case as well, an individual navigation image is generated on the basis of the plurality of acquired sub-observation images. In this manner, the image acquisition section 63 acquires the sub-observation images at the plurality of coordinate positions on the basis of the image acquisition instruction, and acquires the combined observation image obtained by combining the respective sub-observation images as the individual navigation image.

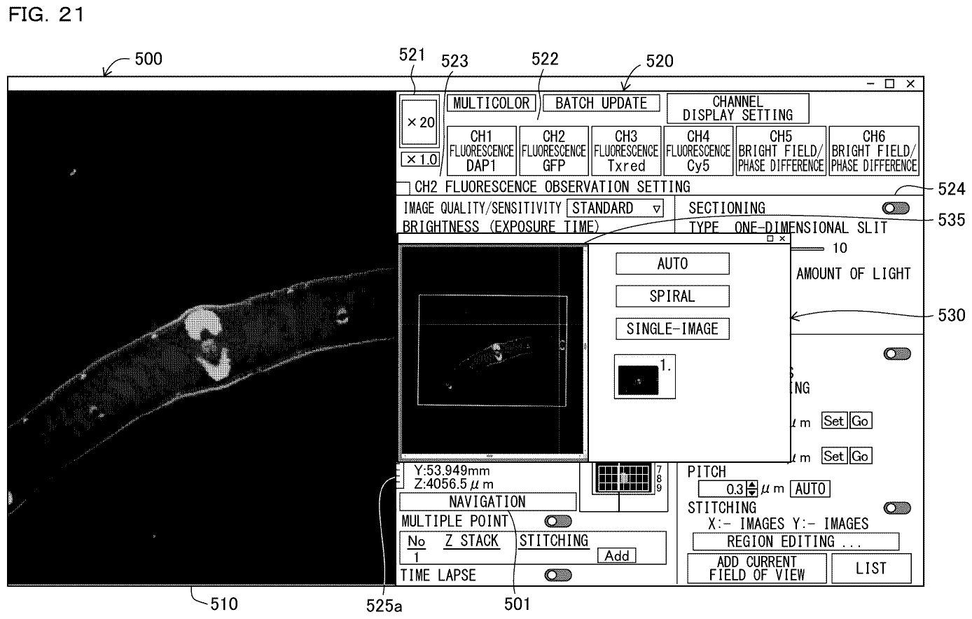

FIG. 21 illustrates a case where only one sub-observation image is acquired and the acquired one sub-observation image is set as an individual navigation image. In a case where the single-image button among the image acquisition instruction buttons 530c illustrated in FIG. 18 is operated, only one sub-observation image is acquired in the current field of view displayed in the live view display region 510.

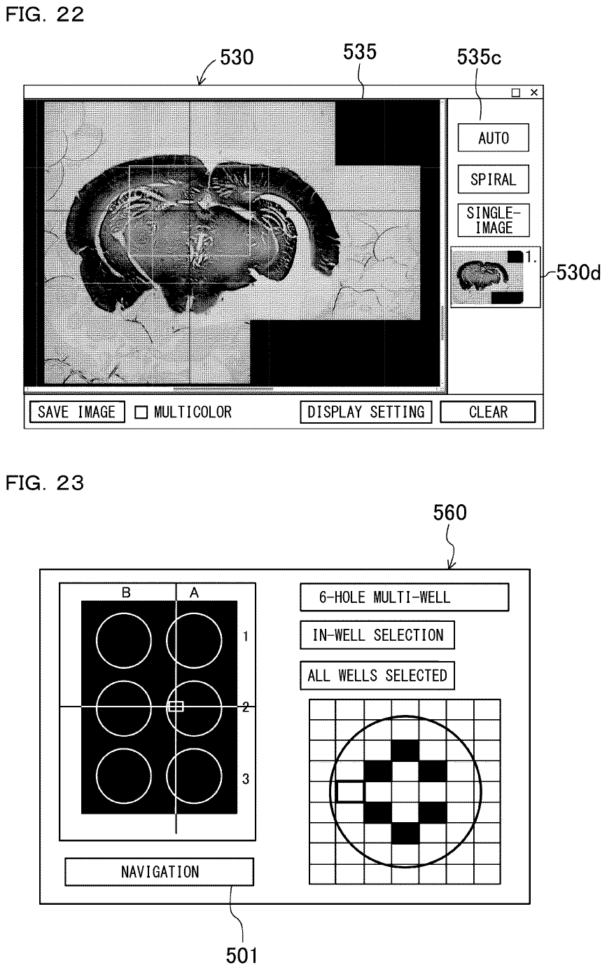

As illustrated in FIG. 22, when the individual navigation image is acquired, the display control section 60 displays the acquired image as a thumbnail image on the enlarged positioning user interface screen 530.

After the individual navigation image is acquired as described above, the observation position is designated on the individual navigation image at the time of observation. At this time, the user performs setting of a Z stack for acquiring a plurality of images with different imaging heights, setting of image stitching for acquiring and stitching a plurality of images by moving in the XY direction, setting of multi-point imaging, and setting of time lapse for acquiring a plurality of images at time intervals in the imaging setting region 524 illustrated in FIG. 11 as necessary. These are referred to as multidimensional imaging. Setting of the multidimensional imaging set in the imaging setting region 524 may be held in a state of being associated with the individual navigation image.

After the multidimensional imaging is set, the microscope body 1 is controlled to execute the multidimensional imaging. At this time, in the case of single image capturing, a bright field monochrome image, a bright field color image, a phase difference monochrome image, a phase difference color image, and a fluorescence monochrome image (pseudo color image) are acquired according to imaging settings. On the other hand, in the case of multicolor image capturing, a bright field monochrome image, a bright field color image, a phase difference monochrome image, a phase difference color image, and a fluorescence monochrome image (pseudo color image)×n are acquired according to imaging settings.

After the first observation of the observation target B, when observing the next observation target B, the user selects an individual navigation image corresponding to the next observation target B. Then, the selection is received by the reception section 61, and the stage S moves to the observation position made to correspond to the individual navigation image received by the reception section 61. That is, the observation target B of the fluorescence microscope A has a shallow imaging depth. For example, in a case where the in-focus position (Z position) is different for each observation target B due to a minute inclination of a slide or a well and the deviation of the in-focus position is large, nothing is displayed in the live view display region 510. By holding the in-focus position at the time of acquiring the individual navigation image for each individual navigation image, it is possible to start from the optimum in-focus position at the time of performing imaging setting, and the convenience of the user is improved.

For example, as illustrated in FIG. 14A, in a case where different observation targets are observed, the process from the field of view search to the observation is repeated for each observation target B. When the captured image is analyzed or the image is confirmed, a desired observation position is designated using the individual navigation image in a case where re-imaging is required, and the stage moves to the designated observation position. After the imaging conditions are restored from the captured image and the imaging setting is adjusted, imaging is performed again.

Furthermore, as illustrated in FIG. 14B, when a plurality of the same observation targets is observed using the well plate, in a case where it is desired to determine an optimum setting (brightness, field of view size, etc.) across N imaging fields of view in the first well plate, it is possible to easily move to individual imaging positions by using the captured individual navigation image. Thereafter, when the second well plate is placed on the stage S, the observation position on the stage is guided to a desired position by the individual navigation image, and the same imaging is executed.

Furthermore, as illustrated in FIG. 14C, in a case where there is only one entire navigation image, the user visually recognizes the individual navigation image in order to search for an Nth position from one navigation image. When the user clicks a desired portion on the individual navigation image, the stage can move to the clicked XY position and execute imaging.

For example, in a case where the observation target B in the cell of the well plate is observed, the imaging condition, the individual navigation image, and the sub-observation image can be held in association with the image captured by placing the first well plate on the stage S. At this time, as in a screen 560 illustrated in FIG. 23, the information on the well plate and the information on the cell address in the well plate can also be held in association with the individual navigation image and the sub-observation image. By holding such information, it is possible to reproduce the observation conditions of the first well plate when observing with the second well plate or the third well plate.

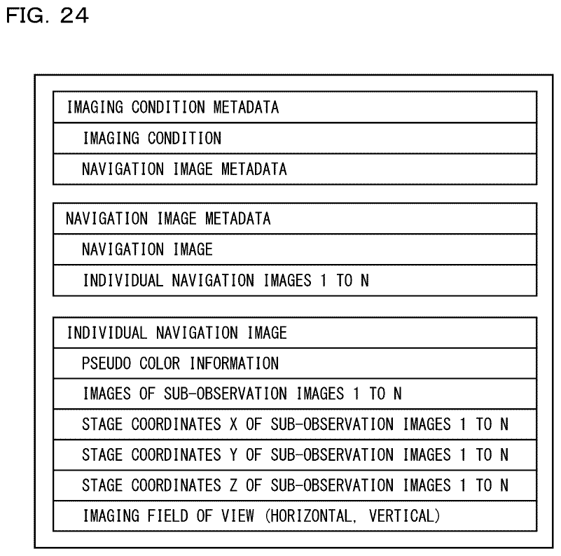

The structure of data held in association with the navigation image has a structure as illustrated in FIG. 24. That is, the imaging condition and the navigation image metadata are included as the imaging condition metadata. The navigation image metadata includes a navigation image and 1 to N individual navigation images. The individual navigation image includes pseudo color information, 1 to N sub-observation images, a stage coordinate X of 1 to N sub-observation images, a stage coordinate Y of 1 to N sub-observation images, a stage coordinate Z of 1 to N sub-observation images, and an imaging field of view (horizontal, vertical). This data structure is an example, and other data structures may be adopted.

The navigation data creation section 69 can store data having a structure as illustrated in FIG. 24 in the storage section 70, for example. Specifically, the navigation data creation section 69 stores navigation data in which an individual navigation image, a plurality of sub-observation images constituting the individual navigation image, a coordinate position where each sub-observation image is acquired, and an observation condition of the sub-observation image are associated with each other in the storage section 70.

On the basis of the coordinate positions and the observation conditions of the plurality of sub-observation images made to correspond to one piece of navigation data from among the navigation data created by the navigation data creation section 69 and stored in the storage section 70, the observation condition reproduction section 67 reproduces, in the second observation target, the acquisition of the sub-observation images at the plurality of coordinate positions and the acquisition of the individual navigation image. Note that, in a case where the acquisition of the sub-observation image and the acquisition of the individual navigation image are reproduced, only at least a part of the coordinate position and the observation condition may be used. For example, in a case where it is desired to acquire an image at the position currently being observed, the acquisition of the image may be reproduced by reproducing only the observation condition without setting the coordinate position as a reproduction target. In short, on the basis of the coordinate positions and the observation conditions of the sub-observation images of the first observation target observed before the second observation target, it is possible to easily observe the second observation target on the basis of various conditions and the like of the first observation target when observing the second observation target thereafter.

### (Display of a Plurality of Navigation)

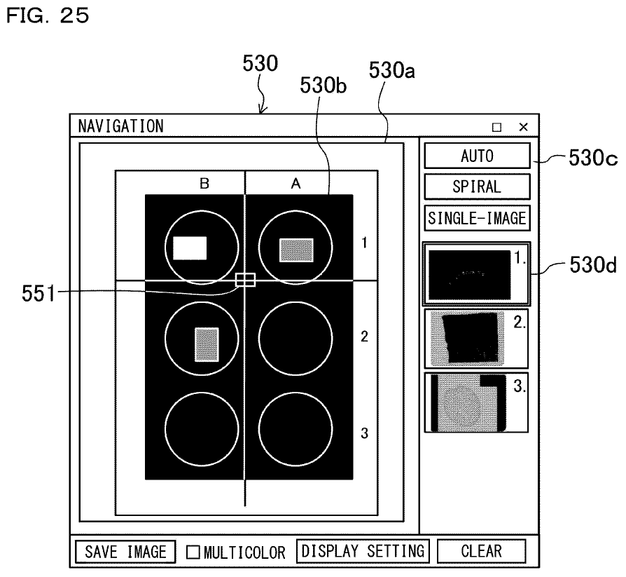

In the present embodiment, a plurality of navigation images can be acquired. For example, FIG. 25 displays three navigation images on an individual positioning user interface screen 530d. When two or more navigation images are acquired, the user can select any one navigation image. Examples of the selection operation of the navigation image include an operation using a mouse or the like.

The navigation image selected by the user becomes an active navigation image, and the navigation image not selected by the user becomes an inactive navigation image. The active navigation image may be an image display obtained by capturing an actual object, and the inactive navigation image may be a frame-only display. The display form of the inactive navigation image may be, for example, transparent display, monochrome display, or the like.

The active navigation image may be displayed in the foreground.

Although not particularly limited, the frame display of the inactive navigation image can be highlighted by, for example, a mouse hover, and the navigation image corresponding to the frame display selected by mouse clicking can be changed to an active navigation image.

### (Confocal Observation)

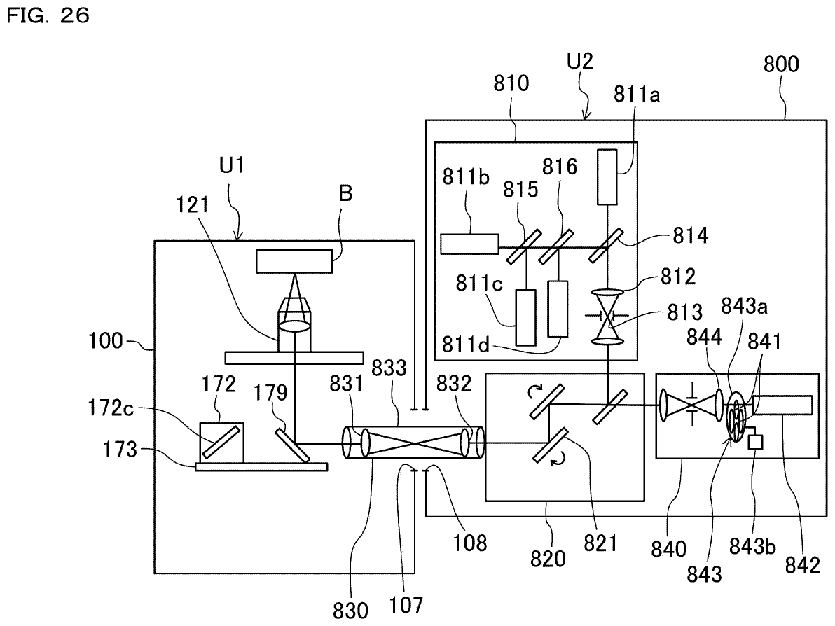

As illustrated in FIG. 26, the fluorescence microscope A may include a wide-field fluorescence observation unit U1 that enables wide-field observation on the basis of wide-field excitation light emitted to the observation target B, and a confocal unit U2 that observes the observation target B using a laser confocal optical system. The wide-field fluorescence observation unit U1 can be used alone, but the confocal unit U2 can be used in a state of being attached to the wide-field fluorescence observation unit U1 as necessary.

The confocal unit U2 includes a confocal light source module 810, a confocal scanner module 820, a laser light guide module 830, and a confocal detection module 840.

The confocal light source module 810 is accommodated in a confocal observation housing 800. The confocal light source module 810 has a structure of multiplexing laser excitation light of four wavelengths with which the observation target B placed on the stage S is irradiated, and includes first to fourth laser excitation light sources 811a, 811b, 811c, and 811d that irradiate the observation target B placed on the stage S with the laser excitation light, an excitation light condenser lens 812 that collects the laser excitation light emitted from the first to fourth laser excitation light sources 811a, 811b, 811c, and 811d, and a first confocal aperture 813 disposed at a focal position of the excitation light condenser lens 812. The excitation light is incident on the incident surface of the first confocal aperture 813. The excitation light that has passed through the first confocal aperture 813 forms a secondary light source of the confocal scanner module 820 at the exit surface of the first confocal aperture 813.

The wavelength band of the laser excitation light emitted by the first laser excitation light source 811a is 500 nm or more and 600 nm or less. Specifically, first laser excitation light source 811a emits light having a wavelength of 561 nm, for example. The second laser excitation light source 811b emits light having a wavelength of 488 nm, for example. The third laser excitation light source 811c emits light having a wavelength of 405 nm, for example. The fourth laser excitation light source 811d emits light having a wavelength of 640 nm, for example. The first to fourth laser excitation light sources 811a, 811b, 811c, and 811d can selectively emit a plurality of laser excitation light having different wavelengths.

The confocal light source module 810 includes a first dichroic mirror 814, a second dichroic mirror 815, and a third dichroic mirror 816 that reflect the laser excitation light. The first dichroic mirror 814 transmits light emitted from the first laser excitation light source 811a, and reflects light emitted from the second laser excitation light source 811b, the third laser excitation light source 811c, and the fourth laser excitation light source 811d.

The second dichroic mirror 815 is provided between the second laser excitation light source 811b and the first dichroic mirror 814. The second dichroic mirror 815 transmits light emitted from the second laser excitation light source 811b and reflects light emitted from the third laser excitation light source 811c.

The third dichroic mirror 816 is provided between the first dichroic mirror 814 and the second dichroic mirror 815. The third dichroic mirror 816 transmits light emitted from the second laser excitation light source 811b and the third laser excitation light source 811c, and reflects light emitted from the fourth laser excitation light source 811d.

The confocal scanner module 820 is a module for two-dimensional scanning of laser excitation light that has passed through the first confocal aperture 813 of the confocal light source module 810. The confocal scanner module 820 includes a scanning mechanism 821 as a mechanism for two-dimensionally scanning the laser excitation light, and can detect fluorescence by a detection section 842 during the forward operation by the scanning mechanism 821 and detect fluorescence by the detection section 842 during the backward operation by the scanning mechanism 821. Furthermore, the confocal scanner module 820 constitutes a confocal optical system that two-dimensionally scans the laser excitation light and scans the focal point on the observation target B via the objective lens 121.

The laser light guide module 830 is a module for guiding the laser excitation light two-dimensionally scanned by the scanning mechanism 821 of the confocal scanner module 820 to the observation target B placed on the stage S via the objective lens 121 of the wide-field fluorescence observation unit U1. The objective lens 121 collects the laser excitation light two-dimensionally scanned by the confocal scanner module 820 on the observation target B.

The confocal detection module 840 is accommodated in the confocal observation housing 800. The confocal detection module 840 includes a plurality of second confocal apertures 841 and a detection section 842. The second confocal aperture 841 is provided at a position conjugate with the first confocal aperture 813. The second confocal aperture 841 is an aperture through which the second fluorescence generated in the observation target B by guiding the laser excitation light to the observation target B placed on the stage S via the laser light guide module 830 and collected by the objective lens 121 passes. The detection section 842 is a part that detects the second fluorescence having passed through the second confocal aperture 841.

The confocal detection module 840 includes an observation light condenser lens 844 that collects light on the second confocal aperture 841. In the present embodiment, a variable pinhole unit 843 is provided in the confocal detection module 840. The variable pinhole unit 843 includes an aperture plate 843a in which a plurality of the second confocal apertures 841 having different diameters is formed, and a plate drive section 843b that disposes a desired second confocal aperture 841 on an optical path by rotating the aperture plate 843a. Each of the plurality of second confocal apertures 841 is an aperture through which confocal fluorescence emitted from the observation target B passes.

A reflection mirror 179 is disposed inside the wide-field fluorescence observation unit U1. The reflection mirror 179 is a member for guiding the laser excitation light emitted from the first to fourth laser excitation light sources 811a, 811b, 811c, and 811d to the objective lens 121.

The reflection mirror 179 is placed on the filter turret 173. The reflection mirror 179 is attached to the upper surface of the filter turret 173 so as to have the same arrangement as the dichroic mirror 172c of the filter cube 172. By controlling the turret drive motor 175, the wide-field excitation light emitted from the illumination section 31 can be guided to the objective lens 121, and the laser excitation light emitted from the first to fourth laser excitation light sources 811a, 811b, 811c, and 811d can also be guided to the objective lens 121. In FIG. 26, laser excitation light emitted from the first to fourth laser excitation light sources 811a, 811b, 811c, 811d is reflected by the reflection mirror 179 and guided to the objective lens 121. On the other hand, in FIG. 3, the wide-field excitation light emitted from the illumination section 31 is reflected by the dichroic mirror 172c of the filter cube 172 and guided to the objective lens 121. As described above, the filter turret 173 and the turret drive motor 175 can switch the optical path between the first optical path for guiding the wide-field excitation light emitted from the illumination section 31 to the objective lens 121 and the second optical path for guiding the laser excitation light emitted from the first to fourth laser excitation light sources 811a, 811b, 811c, and 811d to the objective lens 121.

A mode for detecting the first fluorescence generated in the observation target B by guiding the wide-field excitation light emitted from the illumination section 31 to the observation target B can be referred to as a wide-field fluorescence observation mode. On the other hand, a mode for detecting the second fluorescence generated in the observation target B by guiding the laser excitation light to the observation target B placed on the stage S via the laser light guide module 830 can be referred to as a confocal fluorescence observation mode.

In the wide-field fluorescence observation mode, the absorption filter 172d of the filter cube 172 is disposed in the first optical path for guiding the wide-field excitation light emitted from the illumination section 31 to the objective lens 121, and in the confocal fluorescence observation mode for detecting the second fluorescence, the filter turret 173 is rotated by the turret drive motor 175 such that the reflection mirror 179 is disposed in the second optical path for guiding the laser excitation light emitted from the first to fourth laser excitation light sources 811a, 811b, 811c, and 811d and guided through the laser light guide module 830 to the objective lens 121. Therefore, switching from the wide-field fluorescence observation mode to the confocal fluorescence observation mode and switching from the confocal fluorescence observation mode to the wide-field fluorescence observation mode are quickly executed.

The laser light guide module 830 includes a first lens group 831 and a second lens group 832 as relay lenses including a plurality of lenses. The laser light guide module 830 includes a lens barrel 833 that integrally holds the first lens group 831 and the second lens group 832. The lens barrel 833 is disposed on the wide-field fluorescence observation unit U1 side in the confocal unit U2.

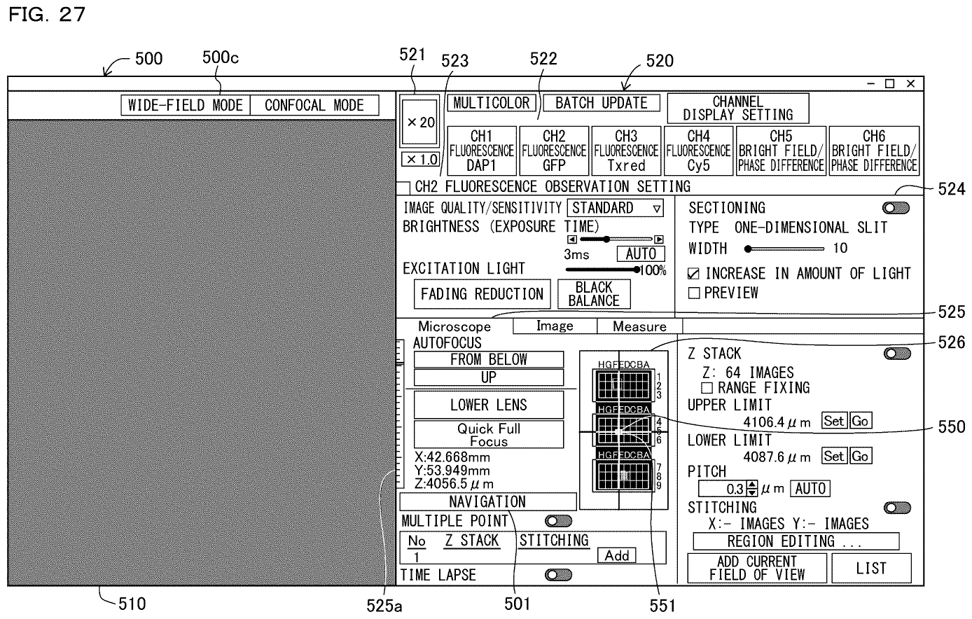

FIG. 27 is a diagram illustrating an example of the display screen 500 capable of switching between the wide-field fluorescence observation mode and the confocal fluorescence observation mode. The display screen 500 is different from the display screen 500 illustrated in FIG. 11 in that a mode switching button 500c is provided on the display screen. The mode switching button 500c is a button for switching between the wide-field observation mode and the confocal observation mode as the observation mode of the observation target B. The operation of the mode switching button 900c can be performed by, for example, a mouse. When the wide-field observation mode is selected by the operation of the mode switching button 900c, the operation is performed in the wide-field observation mode, and when the confocal observation mode is selected by the operation of the mode switching button 900c, the operation is performed in the confocal observation mode.

Since the operation in the wide-field observation mode and the operation in the confocal fluorescence observation mode are possible, for example, in the case of single image capturing, a camera fluorescence monochrome image (pseudo color image) can be acquired in the wide-field observation mode, and a confocal fluorescence monochrome image (pseudo color image) can be acquired in the confocal fluorescence observation mode.

In the case of multicolor image capturing, n camera fluorescence monochrome images (pseudo color images) can be acquired in the wide-field observation mode, and n confocal fluorescence monochrome images (pseudo color images) can be acquired in the confocal fluorescence observation mode.

In the confocal observation mode, since the fluorescence far from the focal point is not received by the confocal aperture, the observation target B may be easily lost even if the Z position is slightly shifted in the case of the thin observation target B. Furthermore, an image of the thick observation target B may be captured at a position different from the slice plane to be observed, and as a result, it may be difficult to capture an image expected by the user. On the other hand, in the present embodiment, since the imaging position (X, Y, Z) can be reproduced by the user selecting the individual navigation image as described above, a desired portion of the observation target B can be easily observed in the confocal observation mode.

Furthermore, bright field, phase difference, camera fluorescence, and confocal fluorescence are included as the imaging condition metadata. Therefore, imaging conditions such as bright field, camera fluorescence, and confocal fluorescence can be given as flags to the individual navigation image. For example, the navigation data creation section 69 can store the individual navigation image and the imaging condition in association with each other in the storage section 70 or the like. When displaying the individual navigation image on the display section 21, the display control section 60 displays the individual navigation image and the imaging condition in correspondence with each other. For example, in the case of an individual navigation image by a camera fluorescence monochrome image, the individual navigation image and a wide-field observation mode as an imaging condition are displayed in correspondence with each other, and in the case of an individual navigation image by a confocal fluorescence monochrome image, the individual navigation image and a confocal observation mode as an imaging condition are displayed in correspondence with each other. Therefore, it is possible to distinguish whether the individual navigation image is an image captured in the wide-field observation mode or an image captured in the confocal observation mode.

The observation condition may include an imaging condition by the camera 151 or an imaging condition by the confocal detection module 840. The navigation data creation section 69 can store the individual navigation image captured by the camera 151 and an imaging condition (first imaging condition) by the camera 151 in the storage section 70 in association with each other. Furthermore, the navigation data creation section 69 can store the individual navigation image captured by the confocal detection module 840 and the imaging condition (second imaging condition) by the confocal detection module 840 in the storage section 70 in association with each other.

The observation condition reproduction section 67 reproduces the imaging condition by the camera 151 on the basis of the first imaging condition associated with the navigation data created by the navigation data creation section 69. The observation condition reproduction section 67 reproduces the imaging condition by the confocal detection module 840 on the basis of the second imaging condition associated with the navigation data created by the navigation data creation section 69.

The above-described embodiments are merely examples in all respects, and should not be construed in a limiting manner. Moreover, all modifications and changes falling within the equivalent scope of the claims are within the scope of the present invention.

As described above, the fluorescence microscope according to the present disclosure can be used, for example, in the case of observing a biological specimen or the like.

What is claimed is:

1. A fluorescence microscope comprising:
a display control section configured to cause a display section to display a positioning user interface screen that designates an observation position of an observation target on a map image of a stage on which the observation target is placed, and a height setting user interface screen that receives adjustment of an observation height of the observation target while displaying an image of the observation target at the observation position designated on the positioning user interface screen;
a reception section configured to receive setting of the observation position on the positioning user interface screen displayed on the display section by the display control section and receive setting of the observation height on the height setting user interface screen displayed on the display section by the display control section;
a first drive section configured to drive the stage to the observation position set by the reception section;
a second drive section configured to drive the stage to the observation height set by the reception section;
an illumination section configured to irradiate the observation target placed on the stage with observation light;
an observation optical system configured to collect light generated from the observation target by being irradiated with the observation light from the illumination section;
a detection section configured to detect the light collected by the observation optical system;
an observation condition setting section configured to set an observation condition of the observation optical system;
an image processing section configured to generate an observation image on a basis of the light detected by the detection section; and
an image acquisition section configured to, on a basis of an image acquisition instruction, acquire the observation image generated by the image processing section as an individual navigation image,
wherein the display control section causes the display section to display a navigation screen in which the individual navigation image acquired by the image acquisition section is superimposed and displayed on a map image of the positioning user interface screen.

2. The fluorescence microscope according to claim 1, wherein the display control section causes the display section to display an individual positioning user interface screen in which a plurality of the individual navigation images acquired by the image acquisition section is arranged.

3. The fluorescence microscope according to claim 1, wherein the display control section causes the display section to display an enlarged positioning user interface screen obtained by enlarging the positioning user interface screen in a window different from the positioning user interface screen.

4. The fluorescence microscope according to claim 3, wherein
the display control section
superimposes and displays the individual navigation image on the positioning user interface screen,
displays an icon indicating the observation position received by the reception section on both the positioning user interface screen and the enlarged positioning user interface screen, and
updates display of the icon indicating the observation position on the positioning user interface screen and the enlarged positioning user interface screen in conjunction with each other according to an update of the observation position received by the reception section.

5. The fluorescence microscope according to claim 1, further comprising a lens selection section configured to select magnification of an objective lens,
wherein the display control section superimposes and displays a rectangle indicating a field of view range on the positioning user interface screen on a basis of the magnification of the objective lens selected by the lens selection section.

6. The fluorescence microscope according to claim 1, further comprising a channel selection section configured to select a color channel,
wherein
the image processing section generates a pseudo color image on a basis of the color channel selected by the channel selection section, and
the display control section displays the pseudo color image generated by the image processing section on the positioning user interface screen as the individual navigation image.

7. The fluorescence microscope according to claim 2, further comprising a coordinate specification section configured to specify stage coordinates of the observation position on a basis of the image acquisition instruction,
wherein the display control section superimposes and displays the individual navigation image at a corresponding observation position on the positioning user interface screen on a basis of the stage coordinates specified by the coordinate specification section.

8. The fluorescence microscope according to claim 7, wherein when the reception section receives selection of the individual navigation image displayed on the individual positioning user interface screen, the first drive section moves the stage to an observation position associated with the received individual navigation image.

9. The fluorescence microscope according to claim 8, wherein
the coordinate specification section specifies an observation height when the image acquisition instruction is received, and
when the reception section receives selection of the individual navigation image displayed on the positioning user interface screen, the second drive section moves the stage to an observation height made to correspond to the received individual navigation image.

10. The fluorescence microscope according to claim 9, wherein
the image acquisition section
acquires a first individual navigation image on a basis of a first image acquisition instruction, and
acquires a second individual navigation image on a basis of a second image acquisition instruction,
the coordinate specification section
specifies a first observation position when the first image acquisition instruction is received, and
specifies a second observation position when the second image acquisition instruction is received, and
the display control section
superimposes and displays the first individual navigation image at a corresponding observation position on the positioning user interface screen on a basis of the first observation position specified by the coordinate specification section,
superimposes and displays the second individual navigation image at a corresponding observation position on the positioning user interface screen on a basis of the second observation position specified by the coordinate specification section, and
causes the first individual navigation image and the second individual navigation image to be arranged and displayed on the individual positioning user interface screen.

11. The fluorescence microscope according to claim 10, wherein
the first individual navigation image is associated with the first observation position and a first observation height specified by the coordinate specification section,
the second individual navigation image is associated with the second observation position and a second observation height specified by the coordinate specification section,
when the reception section receives selection of the first individual navigation image from among the plurality of individual navigation images displayed on the positioning user interface screen, the first drive section and the second drive section are controlled on a basis of the first observation position and the first observation height made to correspond to the first individual navigation image, and
when the reception section receives selection of the second individual navigation image from among the plurality of individual navigation images displayed on the positioning user interface screen, the first drive section and the second drive section are controlled on a basis of the second observation position and the second observation height made to correspond to the second individual navigation image.

12. The fluorescence microscope according to claim 10, wherein
the display control section causes the display section to display the individual positioning user interface screen in which the first individual navigation image and the second individual navigation image acquired by the image acquisition section are arranged,
the first individual navigation image is associated with the first observation position and a first observation height specified by the coordinate specification section,
the second individual navigation image is associated with the second observation position and a second observation height specified by the coordinate specification section,
when the reception section receives selection of the first individual navigation image from among the plurality of individual navigation images arranged and displayed on the individual positioning user interface screen, the first drive section and the second drive section are controlled on a basis of the first observation position and the first observation height made to correspond to the first individual navigation image, and
when the reception section receives selection of the second individual navigation image from among the plurality of individual navigation images displayed on the individual positioning user interface screen, the first drive section and the second drive section are controlled on a basis of the second observation position and the second observation height made to correspond to the second individual navigation image.

13. The fluorescence microscope according to claim 11, further comprising:
a navigation data creation section configured to store the individual navigation image and the observation condition in association with each other in a storage section; and
an observation condition reproduction section configured to reproduce the observation condition on a basis of the observation condition associated with navigation data created by the navigation data creation section,
wherein
when the reception section receives selection of the first individual navigation image from among the plurality of individual navigation images displayed on the positioning user interface screen, the observation condition reproduction section reproduces the observation condition associated with the first individual navigation image, and
when the reception section receives selection of the second individual navigation image from among the plurality of individual navigation images displayed on the positioning user interface screen, the observation condition reproduction section reproduces the observation condition associated with the second individual navigation image.

14. The fluorescence microscope according to claim 13, further comprising an overlap determination section configured to determine whether or not there is an overlap in field of view ranges of the first individual navigation image and the second individual navigation image,
wherein in a case where the overlap determination section determines that there is an overlap in the field of view ranges of the first individual navigation image and the second individual navigation image, and the reception section receives selection of the first individual navigation image and then receives selection of the second individual navigation image, the display control section causes the second individual navigation image to be superimposed and displayed on the first individual navigation image.

15. The fluorescence microscope according to claim 1, wherein
the display control section displays a wide area image as the map image on the positioning user interface screen,
the reception section receives selection of one stage guide from among a plurality of stage guides of different types stored in a storage section, and
the display control section causes the one stage guide received by the reception section to be superimposed and displayed on the wide area image.

16. The fluorescence microscope according to claim 1, wherein the image acquisition section acquires sub-observation images at a plurality of coordinate positions on a basis of the image acquisition instruction, and acquires a stitched observation image obtained by combining the respective sub-observation images as the individual navigation image.

17. The fluorescence microscope according to claim 16, further comprising:
a navigation data creation section configured to store, in a storage section, navigation data in which the individual navigation image, a plurality of the sub-observation images constituting the individual navigation image, coordinate positions at which the respective sub-observation images are acquired, and observation conditions of the sub-observation images are associated with each other; and
on a basis of the coordinate positions and the observation conditions of the plurality of sub-observation images made to correspond to one piece of navigation data from among the navigation data created by the navigation data creation section and stored in the storage section, an observation condition reproduction section configured to reproduce, in a second observation target, acquisition of the sub-observation images at the plurality of coordinate positions and acquisition of the individual navigation image.

18. The fluorescence microscope according to claim 3, further comprising a navigation data creation section configured to store the individual navigation image and an imaging condition in association with each other in a storage section,
wherein the display control section causes the display section to display the individual navigation image and the imaging condition in correspondence with each other.

19. The fluorescence microscope according to claim 13, further comprising a confocal detection module configured to observe an observation target by scanning the observation target with laser excitation light,
wherein
the observation condition includes an imaging condition by the detection section,
the navigation data creation section stores the individual navigation image and the imaging condition by the detection section in association with each other in the storage section, and
the observation condition reproduction section reproduces the imaging condition by the detection section on a basis of the imaging condition by the detection section associated with navigation data created by the navigation data creation section.

20. The fluorescence microscope according to claim 13, further comprising a confocal detection module configured to observe an observation target by scanning the observation target with laser excitation light,
wherein
the observation condition includes an imaging condition by the confocal detection module,
the navigation data creation section stores the individual navigation image and the imaging condition by the confocal detection module in association with each other in the storage section, and
the observation condition reproduction section reproduces the imaging condition by the confocal detection module on a basis of the imaging condition by the confocal detection module associated with navigation data created by the navigation data creation section.
